(19) United States
(12) Patent Application Publication
(10) Pub. No.: US 2016/0186524 A1
(43) Pub. Date: Jun. 30, 2016

(54) SUBSEA IN SITU LASER FOR LASER ASSISTED BLOW OUT PREVENTER AND METHODS OF USE

(71) Applicants: FORO ENERGY, INC., Littleton, CO (US); CHEVRON U.S.A. INC., Houston, TX (US)

(72) Inventors: Brian O. Faircloth, Evergreen, CO (US); Mark S. Zediker, Castle Rock, CO (US)

(73) Assignees: FORO ENERGY, INC., Littleton, CO (US); CHEVRON U.S.A. INC., Houston, TX (US)

(21) Appl. No.: 15/064,165

(22) Filed: Mar. 8, 2016

Related U.S. Application Data
(63) Continuation-in-part of application No. 14/958,864, filed on Dec. 3, 2015.
Application No. 14/958,864 is a continuation-in-part of application No. 12/544,136, filed on Aug. 19, 2009, now Pat. No. 8,511,401.
Application No. 12/544,136 is a continuation-in-part of application No. 14/330,980, filed on Jul. 14, 2014.
Application No. 14/330,980 is a division of application No. 12/543,986, filed on Aug. 19, 2009, now Pat. No. 8,826,973.
Application No. 12/543,986 is a continuation-in-part of application No. 14/099,948, filed on Dec. 7, 2013.
Application No. 14/099,948 is a continuation-in-part of application No. 14/270,288, filed on May 5, 2014, now Pat. No. 9,291,017.
Application No. 14/270,288 is a continuation of application No. 13/034,037, filed on Feb. 24, 2011, now Pat. No. 8,720,584.
Application No. 13/034,037 is a continuation-in-part of application No. 14/015,003, filed on Aug. 30, 2013.
Application No. 14/015,003 is a continuation-in-part of application No. 13/034,183, filed on Feb. 24, 2011, now Pat. No. 8,684,088.
Application No. 13/034,183 is a continuation-in-part of application No. 13/034,017, filed on Feb. 24, 2011, now Pat. No. 8,783,360.
Application No. 13/034,017 is a continuation-in-part of application No. 13/034,175, filed on Feb. 24, 2011, now Pat. No. 8,783,361.
(60) Provisional application No. 62/266,509, filed on Dec. 11, 2015.
(60) Provisional application No. 61/734,809, filed on Dec. 7, 2012.
(60) Provisional application No. 61/786,763, filed on Mar. 15, 2013.

(51) Int. Cl. E21B 33/064; B23K 26/38; B23K 26/122; E21B 33/06

(52) U.S. Cl. CPC E21B 33/064; E21B 33/063; B23K 26/38; B23K 26/122

(57) ABSTRACT

High power sub sea, and sub sea in situ laser beam generation, assemblies and cutting operations for use in riser blowout preventer systems for off shore exploration and production of energy resources, including hydrocarbons. The system utilizes high power sub sea lasers to provide laser beams to laser cutters that are associated with a riser, a blowout preventer, or other sub sea structure.

This application:

(i) claims under 35 U.S.C. §119(e)(1) the benefit of the filing date of Dec. 11, 2015 of provisional application Ser. No. 62/266,509;

(ii) is a continuation-in-part of U.S. patent application Ser. No. 14/958,864, filed Dec. 3, 2015, which is a continuation-in-part of U.S. patent application Ser. No. 12/544,136 filed Aug. 19, 2009 and now issued as U.S. Pat. No. 8,511,401;

(iii) is a continuation-in-part of U.S. patent application Ser. No. 14/330,980, filed Jul. 14, 2014, which is a divisional of U.S. patent application Ser. No. 12/543,986 filed Aug. 19, 2009 and now issued as U.S. Pat. No. 8,826,973;

(iv) is a continuation-in-part of U.S. patent application Ser. No. 14/099,948 filed Dec. 7, 2013, which claims under 35 U.S.C. §119(e)(1) the benefit of the filing date of Dec. 7, 2012 of provisional patent application Ser. No. 61/734,809 and the filing date of Mar. 15, 2013 of provisional patent application Ser. No. 61/786,763;

(v) is a continuation-in-part of U.S. patent application Ser. No. 14/270,288, filed May 5, 2014, which is a continuation of U.S. patent application Ser. No. 13/034,037 filed Feb. 24, 2011 and now issued as U.S. Pat. No. 8,720,584; and,

(vi) is a continuation-in-part of U.S. patent application Ser. No. 14/015,003 filed Aug. 30, 2013, which is a continuation-in-part of U.S. patent application Ser. No. 13/034,183 filed Feb. 24, 2011 and now issued as U.S. Pat. No. 8,684,088, a continuation-in-part of U.S. patent application Ser. No. 13/034,017 filed Feb. 24, 2011 and now issued as U.S. Pat. No. 8,783,360, and a continuation-in-part of U.S. patent application Ser. No. 13/034,175 filed Feb. 24, 2011 and now issued as U.S. Pat. No. 8,783,361,

the entire disclosures of each of which are incorporated herein by reference.

### BACKGROUND OF THE INVENTION

1. Field of the Invention

The present inventions relate to systems used for offshore exploration and production of hydrocarbons, such as oil and natural gas. Thus, and in particular, the present inventions relate to novel systems that generate high power laser beams subsea and utilize high power laser cutters in blow out preventers for flow control and to quickly assist in the management and control of offshore drilling emergency events.

As used herein, unless specified otherwise the terms “blowout preventer,” “BOP,” and “BOP stack” are to be given their broadest possible meaning, and include: (i) devices positioned at or near the borehole surface, e.g., the seafloor, which are used to contain or manage pressures or flows associated with a borehole; (ii) devices for containing or managing pressures or flows in a borehole that are associated with a subsea riser; (iii) devices having any number and combination of gates, valves or elastomeric packers for controlling or managing borehole pressures or flows; (iv) a subsea BOP stack, which stack could contain, for example, ram shears, pipe rams, blind rams and annular preventers; and, (v) other such similar combinations and assemblies of flow and pressure management devices to control borehole pressures, flows or both and, in particular, to control or manage emergency flow or pressure situations.

As used herein, unless specified otherwise “offshore” and “offshore drilling activities” and similar such terms are used in their broadest sense and would include drilling activities on, or in, any body of water, whether fresh or salt water, whether manmade or naturally occurring, such as for example rivers, lakes, canals, inland seas, oceans, seas, bays and gulfs, such as the Gulf of Mexico. As used herein, unless specified otherwise the term “offshore drilling rig” is to be given its broadest possible meaning and would include fixed towers, tenders, platforms, barges, jack-ups, floating platforms, drill ships, dynamically positioned drill ships, semi-submersibles and dynamically positioned semi-submersibles. As used herein, unless specified otherwise the term “seafloor” is to be given its broadest possible meaning and would include any surface of the earth that lies under, or is at the bottom of, any body of water, whether fresh or salt water, whether manmade or naturally occurring. As used herein, unless specified otherwise the terms “well” and “borehole” are to be given their broadest possible meaning and include any hole that is bored or otherwise made into the earth's surface, e.g., the seafloor or sea bed, and would further include exploratory, production, abandoned, reentered, reworked, and injection wells. As used herein the term “riser” is to be given its broadest possible meaning and would include any tubular that connects a platform at, on or above the surface of a body of water, including an offshore drilling rig, a floating production storage and offloading (FPSO) vessel, and a floating gas storage and offloading (FGSO) vessel, to a structure at, on, or near the seafloor for the purposes of activities such as drilling, production, workover, service, well service, intervention and completion.

As used herein the term “drill pipe” is to be given its broadest possible meaning and includes all forms of pipe used for drilling activities; and refers to a single section or piece of pipe. As used herein the terms “stand of drill pipe,” “drill pipe stand,” “stand of pipe,” “stand” and similar type terms are to be given their broadest possible meaning and include two, three or four sections of drill pipe that have been connected, e.g., joined together, typically by joints having threaded connections. As used herein the terms “drill string,” “string,” “string of drill pipe,” string of pipe” and similar type terms are to be given their broadest definition and would include a stand or stands joined together for the purpose of being employed in a borehole. Thus, a drill string could include many stands and many hundreds of sections of drill pipe.

As used herein the term “tubular” is to be given its broadest possible meaning and includes drill pipe, casing, riser, coiled tube, composite tube, production tubing, vacuum insulated tubing (VIT) and any similar structures having at least one channel therein that are, or could be used, in the drilling industry. As used herein the term “joint” is to be given its broadest possible meaning and includes all types of devices, systems, methods, structures and components used to connect tubulars together, such as for example, threaded pipe joints and bolted flanges. For drill pipe joints, the joint section typically has a thicker wall than the rest of the drill pipe. As used herein the thickness of the wall of tubular is the thickness of the material between the internal diameter of the tubular and the external diameter of the tubular.

As used herein, unless specified otherwise “high power laser energy” means a laser beam having at least about 1 kW (kilowatt) of power. As used herein, unless specified otherwise “great distances” means at least about 500 m (meter). As used herein the term “substantial loss of power,” “substantial power loss” and similar such phrases, mean a loss of power of more than about 3.0 dB/km (decibel/kilometer) for a selected wavelength. As used herein the term “substantial power transmission” means at least about 50% transmittance.

2. Discussion of Related Art

Deep Water Drilling

Offshore hydrocarbon exploration and production has been moving to deeper and deeper waters. Today drilling activities at depths of 5000 ft, 10,000 ft and even greater depths are contemplated and carried out. For example, its has been reported by RIGZONE, www.rigzone.com, that there are over 330 rigs rated for drilling in water depths greater than 600 ft (feet), and of those rigs there are over 190 rigs rated for drilling in water depths greater than 5,000 ft, and of those rigs over 90 of them are rated for drilling in water depths of 10,000 ft. When drilling at these deep, very-deep and ultra-deep depths the drilling equipment is subject to the extreme conditions found in the depths of the ocean, including great pressures and low temperatures at the seafloor.

Further, these deep water drilling rigs are capable of advancing boreholes that can be 10,000 ft, 20,000 ft, 30,000 ft and even deeper below the sea floor. As such, the drilling equipment, such as drill pipe, casing, risers, and the BOP are subject to substantial forces and extreme conditions. To address these forces and conditions drilling equipment, for example, risers, drill pipe and drill strings, are designed to be stronger, more rugged, and in may cases heavier. Additionally, the metals that are used to make drill pipe and casing have become more ductile.

Typically, and by way of general illustration, in drilling a subsea well an initial borehole is made into the seabed and then subsequent and smaller diameter boreholes are drilled to extend the overall depth of the borehole. Thus, as the overall borehole gets deeper its diameter becomes smaller; resulting in what can be envisioned as a telescoping assembly of holes with the largest diameter hole being at the top of the borehole closest to the surface of the earth.

Thus, by way of example, the starting phases of a subsea drill process may be explained in general as follows. Once the drilling rig is positioned on the surface of the water over the area where drilling is to take place, an initial borehole is made by drilling a 36″ hole in the earth to a depth of about 200-300 ft. below the seafloor. A 30″ casing is inserted into this initial borehole. This 30″ casing may also be called a conductor. The 30″ conductor may or may not be cemented into place. During this drilling operation a riser is generally not used and the cuttings from the borehole, e.g., the earth and other material removed from the borehole by the drilling activity, are returned to the seafloor. Next, a 26″ diameter borehole is drilled within the 30″ casing, extending the depth of the borehole to about 1,000-1,500 ft. This drilling operation may also be conducted without using a riser. A 20″ casing is then inserted into the 30″ conductor and 26″ borehole. This 20″ casing is cemented into place. The 20″ casing has a wellhead secured to it. (In other operations an additional smaller diameter borehole may be drilled, and a smaller diameter casing inserted into that borehole with the wellhead being secured to that smaller diameter casing.) A BOP is then secured to a riser and lowered by the riser to the sea floor; where the BOP is secured to the wellhead. From this point forward, in general, all drilling activity in the borehole takes place through the riser and the BOP.

The BOP, along with other equipment and procedures, is used to control and manage pressures and flows in a well. In general, a BOP is a stack of several mechanical devices that have a connected inner cavity extending through these devices. BOP's can have cavities, e.g., bore diameters ranging from about 4⅙″ to 26¾.″ Tubulars are advanced from the offshore drilling rig down the riser, through the BOP cavity and into the borehole. Returns, e.g., drilling mud and cuttings, are removed from the borehole and transmitted through the BOP cavity, up the riser, and to the offshore drilling rig. The BOP stack typically has an annular preventer, which is an expandable packer that functions like a giant sphincter muscle around a tubular. Some annular preventers may also be used or capable of sealing off the cavity when a tubular is not present. When activated, this packer seals against a tubular that is in the BOP cavity, preventing material from flowing through the annulus formed between the outside diameter of the tubular and the wall of the BOP cavity. The BOP stack also typically has ram preventers. As used herein unless specified otherwise, the term “ram preventer” is to be given its broadest definition and would include any mechanical devices that clamp, grab, hold, cut, sever, crush, or combinations thereof, a tubular within a BOP stack, such as shear rams, blind rams, blind-shear rams, pipe rams, variable rams, variable pipe rams, casing shear rams, and preventers such as Hydril's HYDRIL PRESSURE CONTROL COMPACT Ram, Hydril Pressure Control Conventional Ram, HYDRIL PRESSURE CONTROL QUICK-LOG, and HYDRIL PRESSURE CONTROL SENTRY Workover, SHAFFER ram preventers, and ram preventers made by Cameron.

Thus, the BOP stack typically has a pipe ram preventer and my have more than one of these. Pipe ram preventers typically are two half-circle like clamping devices that are driven against the outside diameter of a tubular that is in the BOP cavity. Pipe ram preventers can be viewed as two giant hands that clamp against the tubular and seal-off the annulus between the tubular and the BOP cavity wall. Blind ram preventers may also be contained in the BOP stack, these rams can seal the cavity when no tubulars are present.

Pipe ram preventers and annular preventers typically can only seal the annulus between a tubular in the BOP and the BOP cavity; they cannot seal-off the tubular. Thus, in emergency situations, e.g., when a “kick” (a sudden influx of gas, fluid, or pressure into the borehole) occurs, or if a potential blowout situations arises, flows from high downhole pressures can come back up through the inside of the tubular, the annulus between the tubular and riser, and up the riser to the drilling rig. Additionally, in emergency situations, the pipe ram and annular preventers may not be able to form a strong enough seal around the tubular to prevent flow through the annulus between the tubular and the BOP cavity. Thus, BOP stacks include a mechanical shear ram assembly. Mechanical shear rams are typically the last line of defense for emergency situations, e.g., kicks or potential blowouts. (As used herein, unless specified otherwise, the term “shear ram” would include blind shear rams, shear sealing rams, shear seal rams, shear rams and any ram that is intended to, or capable of, cutting or shearing a tubular.) Mechanical shear rams function like giant gate valves that supposed to quickly close across the BOP cavity to seal it. They are intended to cut through any tubular is in the BOP cavity that would potentially block the shear ram from completely sealing the BOP cavity.

BOP stacks can have many varied configurations, which are dependent upon the conditions and hazards that are expected during deployment and use. These components could include, for example, an annular type preventer, a rotating head, a single ram preventer with one set of rams (blind or pipe), a double ram preventer having two sets of rams, a triple ram type preventer having three sets of rams, and a spool with side outlet connections for choke and kill lines. Examples of existing configurations of these components could be: a BOP stack having a bore of 7 1/16″ and from bottom to top a single ram, a spool, a single ram, a single ram and an annular preventer and having a rated working pressure of 5,000 psi; a BOP stack having a bore of 13⅝″ and from bottom to top a spool, a single ram, a single ram, a single ram and an annular preventer and having a rated working pressure of 10,000 psi; and, a BOP stack having a bore of 18¾″ and from bottom to top, a single ram, a single ram, a single ram, a single ram, an annular preventer and an annular preventer and having a rated working pressure of 15,000 psi. (As used herein the term “preventer” in the context of a BOP stack, would include all rams, shear rams, and annular preventers, as well as, any other mechanical valve like structure used to restrict, shut-off or control the flow within a BOP bore.)

BOPS need to contain the pressures that could be present in a well, which pressures could be as great as 15,000 psi or greater. Additionally, there is a need for shear rams that are capable of quickly and reliably cutting through any tubular, including drilling collars, pipe joints, and bottom hole assemblies that might be present in the BOP when an emergency situation arises or other situation where it is desirable to cut tubulars in the BOP and seal the well. With the increasing strength, thickness and ductility of tubulars, and in particular tubulars of deep, very-deep and ultra-deep water drilling, there has been an ever increasing need for stronger, more powerful, and better shear rams. This long standing need for such shear rams, as well as, other information about the physics and engineering principles underlying existing mechanical shear rams, is set forth in: West Engineering Services, Inc., “Mini Shear Study for U.S. Minerals Management Services” (Requisition No. 2-1011-1003, December 2002); West Engineering Services, Inc., “Shear Ram Capabilities Study for U.S. Minerals Management Services” (Requisition No. 3-4025-1001, September 2004); and, Barringer & Associates Inc., “Shear Ram Blowout Preventer Forces Required” (Jun. 6, 2010, revised Aug. 8, 2010).

In an attempt to meet these ongoing and increasingly important needs, BOPS have become larger, heavier and more complicated. Thus, BOP stacks having two annular preventers, two shear rams, and six pipe rams have been suggested. These BOPS can weigh many hundreds of tons and stand 50 feet tall, or taller. The ever-increasing size and weight of BOPS presents significant problems, however, for older drilling rigs. Many of the existing offshore rigs do not have the deck space, lifting capacity, or for other reasons, the ability to handle and use these larger more complicated BOP stacks.

As used herein the term “riser” is to be given its broadest possible meaning and would include any tubular that connects a platform at, on or above the surface of a body of water, including an offshore drilling rig, a floating production storage and offloading (“FPSO”) vessel, and a floating gas storage and offloading (“FGSO”) vessel, to a structure at, on, or near the seafloor for the purposes of activities such as drilling, production, workover, service, well service, intervention and completion.

Risers, which would include marine risers, subsea risers, and drilling risers, are essentially large tubulars that connect an offshore drilling rig, vessel or platform to a borehole. Typically a riser is connected to the rig above the water level and to a BOP on the seafloor. Risers can be viewed as essentially a very large pipe, that has an inner cavity through which the tools and materials needed to drill a well are sent down from the offshore drilling rig to the borehole in the seafloor and waste material and tools are brought out of the borehole and back up to the offshore drilling rig. Thus, the riser functions like an umbilical cord connecting the offshore rig to the wellbore through potentially many thousands of feet of water.

Risers can vary in size, type and configuration. All risers have a large central or center tube that can have an outer diameters ranging from about 13⅜″ to about 24″ and can have wall thickness from about ⅝″ to ⅞″ or greater. Risers come in sections that can range in length from about 49 feet to about 82 feet, and typically for ultra deep water applications, are about 75 feet long. Thus, to have a riser extend from the rig to a BOP on the seafloor the rise sections are connected together by the rig and lowered to the seafloor.

The ends of each riser section have riser couplings that enable the large central tube of the riser sections to be connected together. The term “riser coupling” should be given its broadest possible meaning and includes various types of coupling that use mechanical means, such as, flanges, bolts, clips, bowen, lubricated, dogs, keys, threads, pins and other means of attachment known to the art or later developed by the art. Thus, by way of example riser couplings would include flange-style couplings, which use flanges and bolts; dog-style couplings, which use dogs in a box that are driven into engagement by an actuating screw; and key-style couplings, which use a key mechanism that rotates into locking engagement. An example of a flange-style coupling would be the VetcoGray HMF. An example of a dog-style coupling would be the VetcoGray MR-10E. An example of a key-style coupling would be the VetcoGray MR-6H SE

Each riser section also has external pipes associated with the large central tube. These pipes are attached to the outside of the large central tube, run down the length of the tube or riser section, and have their own connections that are associated with riser section connections. Typically, these pipes would include a choke line, kill line, booster line, hydraulic line and potentially other types of lines or cables. The choke, kill, booster and hydraulic lines can have inner diameters from about 3″ (hydraulic lines may be as small as about 2.5″) to about 6.5″ or more and wall thicknesses from about ½″ to about 1″ or more.

Situations arise where it may be necessary to disconnect the riser from the offshore drilling rig, vessel or platform. In some of these situations, e.g., drive-off of a floating rig, there may be little or no time, to properly disconnect the riser. In others situations, such as weather related situations, there may be insufficient time to pull the riser string once sufficient weather information is obtained; thus forcing a decision to potentially unnecessarily pull the riser. Thus, and particularly for deep, very deep and ultra deep water drilling there has existed a need to be able to quickly and with minimal damage disconnect a riser from an offshore drilling rig.

In offshore drilling activities critical and often times emergency situations arise. These situations can occur quickly, unexpectedly and require prompt attention and remedial actions. Although these offshore emergency situations may have similar downhole causes to onshore drilling emergency situations, the offshore activities are much more difficult and complicated to manage and control. For example, it is generally more difficult to evacuate rig personnel to a location, away from the drilling rig, in an offshore environment. Environmentally, it is also substantially more difficult to mitigate and manage the inadvertent release of hydrocarbons, such as in an oil spill, or blowout, for an offshore situation than one that occurs onshore. The drilling rig, in an offshore environment, can be many tens of thousands of feet away from the wellhead. Moreover, the offshore drilling rig is fixed to the borehole by the riser and any tubulars that may be in the borehole. Such tubulars may also interfere with, inhibit, or otherwise prevent, well control equipment from functioning properly. These tubulars and the riser can act as a conduit bringing dangerous hydrocarbons and other materials into the very center of the rig and exposing the rig and its personnel to extreme dangers.

Thus, there has long been a need for systems that can quickly and reliably address, assist in the management of, and mitigate critical and emergency offshore drilling situations. This need has grown ever more important as offshore drilling activities have moved into deeper and deeper waters. In general, it is believed that the art has attempted to address this need by relying upon heavier and larger pieces of equipment; in essence by what could be described as using brute force in an attempt to meet this need. Such brute force methods, however, have failed to meet this long-standing and important need

### SUMMARY

In offshore drilling operations it has long been desirable to have the ability to quickly and in a controlled manner cut or weaken tubulars that extend from an offshore drilling rig to, and into, a borehole to assist in the control and management of emergency situations that arise during deep sea drilling activities. The present invention, among other things, solves this need by providing the articles of manufacture, devices and processes taught herein.

Thus, there is provided a blowout preventer stack having: a ram movable from a first position to a second position, thereby defining a ram path; a sub sea laser assembly having a sub sea laser in optical association with a laser cutter for generating and emitting a high power laser beam and thereby defining a laser beam path; and, the sub sea laser cutter positioned relative to the ram and facing a pressure containment cavity formed within the stack, wherein the beam path enters into the pressure containment cavity and the second position of the ram is located within the pressure containment cavity.

Further there is provided methods, apparatus and systems having one or more of the following features wherein the stack has a frame and a sub sea laser housing; the sub sea laser housing encompassing and protecting the sub sea laser from the sub sea environment; wherein the sub sea laser housing has a means for cooling the sub sea laser; wherein the sub sea laser has an array of a plurality of diode lasers, the diode lasers each generating an initial laser beam having a wavelength of about 400 nm to about 900 nm; a beam combiner; whereby the beam combiner provides an operational laser beam having a power of at least about 5 kW; and wherein the sub sea laser has an array of a plurality of diode lasers, the diode lasers each generating an initial laser beam having a wavelength of about 400 nm to about 900 nm; a beam combiner; whereby the beam combiner provides an operational laser beam having a power of at least about 5 kW.

Still further there are provided methods, apparatus and systems having one or more of the following features: wherein the sub sea laser assembly has a power source, a semiconductor laser, and a means for cooling the laser; wherein the power source is selected from the group consisting of an electric power line, a battery, a generator and an optical fiber; wherein the means cooling is selected from the group consisting of non circulating fluid in thermal association with a body of water in which the blowout preventer is submerged, a solid member in thermal association with a body of water in which the blowout preventer is submerged, a circulating fluid, and a body of water in which the blowout preventer is submerged; wherein the sub sea laser has a means for cooling the sub sea laser; wherein the means cooling is selected from the group consisting of non circulating fluid in thermal association with a body of water in which the blowout preventer is submerged, a solid member in thermal association with a body of water in which the blowout preventer is submerged, a circulating fluid, a circulating fluid having a liquid from the body of water in which the blowout preventer is submerged, and a body of water in which the blowout preventer is submerged; and wherein the sub sea laser has an array of a plurality of diode lasers, the diode lasers each generating an initial laser beam having a wavelength of about 400 nm to about 900 nm; a beam combiner; whereby the beam combiner provides an operational laser beam having a power of at least about 5 kW.

Additionally, there is provided a blowout preventer having: a sub sea in situ laser assembly, the assembly having a plurality of semiconductor lasers and a laser cutter for emitting a high power operational laser beam having a wavelength of about 400 nm to about 1,100 nm and a power of at least about 2 kW; a pressure containment cavity within a stack for passing tubulars therethrough; and, the laser cutter defining a beam path, the beam path extending into the pressure containment cavity.

Moreover, there are provided methods, apparatus and systems having one or more of the following features: wherein the plurality of semiconductor lasers has at least 10 diode lasers; wherein the diode lasers have a wavelength form 400 nm to 500 nm; wherein the diode lasers have a wavelength form 500 nm to 600 nm; wherein the diode lasers have a wavelength form 600 nm to 880 nm; having a laser cooling assembly; and having a laser cooling assembly selected from the group consisting of a non circulating fluid in thermal association with a body of water in which the blowout preventer is submerged, a solid member in thermal association with a body of water in which the blowout preventer is submerged, a circulating fluid, a circulating fluid having liquid from a body of water in which the blowout preventer is submerged, and a body of water in which the blowout preventer is submerged.

Moreover there is provided a subsea blowout preventer having: a sub sea laser assembly, the assembly having a protective laser housing, the housing containing and protecting a semiconductor laser, a beam combiner, and a laser cutter for emitting a high power operational laser beam having a wavelength of about 400 nm to about 1,100 nm and a power of at least about 2 kW; a ram preventer, having a ram; a pressure containment cavity for passing tubulars therethrough; the laser cutter having a beam path; the ram capable of movement into the pressure containment cavity; an area within the pressure containment cavity for engagement of the ram with a tubular; and, the beam path directed adjacent the area within the pressure containment cavity for engagement of the ram with the tubular.

Yet additionally there is provided a laser assisted blowout preventer having: a frame; a blowout preventer stack mechanically associated with the frame, whereby the frame at least in part encompasses and protects the blowout preventer stack, the blowout preventer stack having; a pressure containment cavity formed within the blowout preventer stack for passing tubulars therethrough; and, a sub sea high power laser assembly having a protective housing, a laser, a power source, and a laser cutter, the laser cutter positioned adjacent the pressure containment cavity.

Still further there are provided systems, methods and apparatus having one or more of the following features: wherein the housing is mechanically affixed to the frame; wherein the housing is a body of a laser shear ram; and the laser assembly is an in situ laser assembly.

Furthermore, there is provided a laser assisted subsea blowout preventer drilling system, the system having: a subsea riser; a blowout preventer stack; the blowout preventer stack having: a blowout preventer stack cavity for passing tubulars therethrough, wherein the blowout preventer stack cavity is in fluid communication with the subsea riser; a sub sea laser delivery assembly having a protective housing, a plurality of diode lasers, a beam combiner and a laser cutter for providing a high power laser beam; and, a shear ram assembly having an opposed pair of shear rams, wherein the laser delivery assembly is mechanically associated with the shear ram assembly.

Yet additionally, there is provided an offshore drilling rig having a laser assisted subsea blowout preventer system for the rapid cutting of tubulars in the blowout preventer during emergency situations, the laser system having: a riser capable of being lowered from and operably connected to an offshore drilling rig to a depth at or near a seafloor; a blowout preventer capable of being operably connected to the riser and lowered by the riser from the offshore drilling rig to the seafloor; a sub sea high power laser assembly having a sub sea laser and a laser cutter; and, the laser cutter operably associated with the blowout preventer and riser, whereby the laser cutter is capable of being lowered to at or near the seafloor and upon activation deliver a high power laser beam to a tubular that is within the blowout preventer.

Yet still further there is provided a subsea blowout preventer stack having: a ram movable from a first position to a second position; and a sub sea high power laser assembly for directing a high power operational laser beam into a pressure containment cavity formed within the stack.

Still further there is provided a shear laser module for use in a blowout preventer stack, the module having: a body having a first blowout preventer stack connector and a second blowout preventer stack connector; the body having a cavity for passing tubulars therethrough and conveying and controlling a flow of a drilling fluid therethrough; and, a sub sea in situ laser assembly having a laser and a laser cutter in the body and having a beam path; wherein the beam path travels from the laser cutter into the cavity and to any tubular that may be in the cavity.

Yet additionally, there is provided methods, systems and apparatus having one or more of the following features: wherein the laser assembly has a plurality of diode lasers; wherein the laser assembly has a cooling assembly; wherein the laser assembly has a means for cooling the laser; and wherein the laser assembly has a beam combiner.

Further there is provided a laser module for use with a marine riser, the laser module having: a housing configured for mechanical association with a marine riser, the housing defining an inner area, whereby at least a portion of the marine riser is contained within the inner area upon engagement of the housing with the riser; the housing having a sub surface laser assembly in optical communication with a first laser cutter and a second laser cutter; the first and second laser cutters, being positioned within the housing and the first and second laser cutters each having a laser discharge end; a first beam path extending from the laser discharge end of the first laser cutter to the inner area of the housing; and a second beam path extending from the laser discharge end of the second laser cutter to the inner area of the housing.

Furthermore, there is provided a laser-riser blowout preventer package for operably releasably associating an offshore drilling rig, a vessel or a platform on a surface of a body the water with a borehole in a seafloor of the body of water, the laser-riser blowout preventer package having: a riser section having a first and a second end, wherein the first end has a first coupling and the second end has a second coupling; a laser module, having a sub sea in situ laser assembly, operably associated with the riser section; and, and a blowout preventer configured to be operably associated with the riser section and the borehole; wherein, when the laser-riser blowout preventer package is deployed and operably associating the offshore drilling rig with the borehole in the seafloor the offshore drilling rig, vessel or platform is mechanically connected and in fluid communication with the borehole; and, the laser module upon firing a laser beam can completely cut the riser section at a predetermined location on the riser section, thereby releasing the offshore drilling rig, vessel or platform from the blowout preventer.

### BRIEF DESCRIPTION OF THE DRAWINGS

FIG. 1 is a perspective view of an embodiment of a system in accordance with the present inventions.

FIG. 2 is a partial cut away cross-sectional view of an embodiment of a laser shear ram assembly in accordance with the present inventions.

FIG. 3A is a partial cut away cross-sectional view of an embodiment of a laser shear ram assembly in accordance with the present inventions.

FIG. 3B is a detailed cross-sectional view of a portion of the laser shear ram assembly of FIG. 3A.

FIGS. 4A, 4B, 4C & 4D are transverse cross-sectional views of the embodiment of the laser shear ram assembly of FIG. 3A.

FIG. 5 is a transverse cross-sectional view of an embodiment of a laser shear ram assembly in accordance with the present inventions.

FIG. 6 is a transverse cross-sectional view of an embodiment of a laser shear ram assembly in accordance with the present inventions.

FIG. 7 is a partial cut away cross-sectional view of an embodiment of a laser shear ram assembly in accordance with the present inventions.

FIG. 8 is a schematic of an embodiment of a laser assisted BOP stack in accordance with the present inventions.

FIG. 8A is an enlarged schematic view of the sub sea in situ laser assembly contained within the embodiment of FIG. 8.

FIG. 9 is a schematic of an embodiment of a laser assisted BOP stack in accordance with the present inventions.

FIG. 10 is a schematic of an embodiment of a laser assisted BOP stack in accordance with the present inventions.

FIG. 11 is a partial cut away cross-sectional view of a section of an embodiment of a shear laser module (“SLM”) in accordance with the present inventions.

FIGS. 12 is a partial cut away cross-sectional view of a section of an embodiment of an SLM in accordance with the present inventions.

FIG. 13 is a partial cut away cross-sectional view of a section of another embodiment of an SLM in accordance with the present inventions.

FIGS. 13A, 13B & 13C are transverse cross-sectional views of the SLM of FIG. 13 taken along line B-B.

FIGS. 14, 14A & 14B are schematic illustrations of laser beam paths in accordance with the present inventions.

FIG. 15A is a partial cutaway view of an embodiment of a laser module and riser sections in accordance with the present inventions.

FIG. 15B is a transverse cross-section view of the laser module and riser sections of FIG. 15A.

FIG. 15C is an enlarged view of section C of FIG. 15A.

FIG. 16A is a partial cutaway view of another embodiment of a laser module and riser sections in accordance with the present inventions.

FIG. 16B is a transverse cross-section view of the laser module and riser sections of FIG. 15A.

FIG. 17A is a perspective view of an embodiment of a laser riser section in accordance with the present inventions.

FIG. 17B is a transverse cross-section view of the laser riser section of FIG. 17A.

### DESCRIPTION OF THE PREFERRED EMBODIMENTS

In general, the present inventions relate to the generation of high power laser beams subsea and the use of these sub sea generated laser beams in laser beam delivery systems that are associated with BOPS and which can deliver controlled, precise and predetermined laser energy to address flow control and in particular crisis and emergency situations during offshore drilling activities. In a preferred embodiment the sub sea generated laser beams are in the blue, blue to green and green wavelengths, and are minimally absorbed by the fluids that can be present in the laser beam path, such as within a BOP cavity.

Thus, generally, in an embodiment of an offshore drilling rig has a sub sea laser beam delivery system operably associated with the riser, the BOP, and both. The drilling rig has a riser that is deployed and connects the drilling rig with a borehole that extends below the seafloor. The upper portion of the riser when deployed is closest to the surface of the water and is connected to the drilling rig. The riser extends from the drilling rig and is connected to the BOP stack. The riser is made up of sections that are connected together, by riser couplings. Thus, the riser may also be referred to as a riser string. The lower portion of the riser string is connected to the BOP stack by a riser-BOP connecter. The riser-BOP connecter attaches to, or has, a flex joint, which may also be referred to as a flex connection or ball joint.

In general, the BOP stack has two component assemblies: an upper component assembly, which may be referred to as the lower marine riser package (LMRP), and a lower component assembly, which may be referred to as the lower BOP stack or the BOP proper. The BOP stack has a wellhead connecter that attaches to a wellhead, which is attached to borehole. The LMRP of the BOP stack may have a frame that houses for example an annular preventer. The lower component assembly of the BOP may have a frame that houses an annular preventer, a laser shear ram assembly, a shear laser module (“SLM”) and a ram preventer.

The sub sea lasers, and laser cutting assemblies can be located at one, two, three, and more locations along the riser-BOP assembly. The sub sea lasers can be incorporated into, a part of, or adjacent, various components of the riser-BOP assembly, such as, an LMRP, an SLM, a BOP stack, a flex joint, a connector, a frame, a riser, and a riser joint.

Preferably, lasers, and in particular high power laser generation systems and assemblies, are located at, as a part of, adjacent to, or near the laser cutters. In these preferred embodiments the laser will be located subsea and generate high power laser beams for use by the cutters subsea. Thus, in these preferred embodiments these lasers can be associated with the BOP frame (adjacent, and preferably inside of the frame), the LMRP, the stack, the flex joint, the BOP riser connector, the riser joint, on the seafloor, or just above the seafloor, and more preferably in a subsea laser containment housing (to protect the laser and related components from pressure, water, the sub sea environment, and combinations and variations of these and other environmental conditions). If the laser generation system is located within a ram sheer or other larger component of a riser-BOP assembly, that riser-BOP component can also be the laser generation containment system housing, and provide protection from the sub sea environmental conditions. Thus, in some embodiments the laser generation systems can be inside of a shear module, they can be integral with a riser joint, they can be integral with a riser section, or contained within, or integral with, other sub sea components.

In an embodiment, the laser generation system propagates the high power laser beam directly at the target (e.g., laser beam is generated and launched into optics and through a pressure window, by directly it is meant that no transmission fiber is used between the laser, any optics, and the target along the laser beam's path). Thus, in this embodiment where the laser beam path from the laser to the target is direct, the laser generation system is also the laser cutter or laser cutter assembly (i.e, an integral laser generation, laser cutter system).

In an embodiment the laser generation system, is sub sea and adjacent to, or generally near to the laser cutters (i.e., about 5 feet away from, about 25 feet away from, about 50 feet away from, about 200 feet away from, and further or closer). In this embodiment the sub sea laser generation system launches the laser beam into a short high power fiber cable (e.g., less than about 200 feet in length, less than about 100 feet in length, less than about 25 feet in length, and less than about 5 feet in length, and shorter) that is optically connected to the laser cutter assembly, and thus transmits the laser beam to the the laser cutter assembly, which cutter assembly then launches the high power laser beam at the target. A hollow tube, housing, e.g., a beam guide, may also be used to protect the laser beam path through free space within the beam guide, and thus transmit the laser beam from the sub sea laser source to the cutters.

In preferred embodiments, the laser beam generation is in situ, (i.e., the laser is within a part of the sub sea riser-BOP assembly, and the laser beam is generated in that part of the sub sea riser-BOP assembly). Once deployed, the laser beam generation, and laser beam generation system, is a subsea, in situ, laser generation system. Thus, the term “sub sea in situ laser generation system” means that the laser beam is generated below the surface of the body of water, and within a subsea component or structure, such sub sea oil or gas field components, and a part of the riser-BOP assembly.

It being understood that while the primary focus of the embodiments of the present inventions are directed to BOPS, risers, and components of the riser-BOP assembly, subsea laser generation systems can be used with any sub sea energy (e.g., hydrocarbon or geothermal) exploration, production, work over, completion, and plugging and abandonment components and activities. Embodiments of the present invention include sub sea, and sub sea in situ, laser generation systems and integral laser generation, laser cutter system for use in, and with, any subsea activities and for any type of sub sea components, including for example water in takes and outlets, such as for power plants, municipal or industrial purposes. Thus, embodiments of the present inventions include other sub sea components and activities that extend beyond, or otherwise are not related to oil field and hydrocarbon exploration and production.

The sub sea laser generation systems, can be powered, by electrical cables, optical cables (either as a pump source, or as an optical-to-electrical source), by a battery, a subsea generator (gas, electric, pneumatic, chemical-thermal), or other source of power (electrical, chemical, chemical-thermal, tidal, optical, etc.) to provide lasing sub sea, and thus, the generation of the sub sea laser beams.

One, two three, four or more sub sea laser beams, including in situ sub sea laser beams are high power laser beams, having a power of at least about 1 kW, at least about 2 kW, at least about 5 kW, at least about 10 kW, at least about 15 kW, at least about 20 kW, at least about 40 kW and more.

The laser beam generated subsea, and preferably subsea, in situ, can preferably have wavelengths of less than 2,100 nm, less than 1,500 nm, and less than 800 nm. In a preferred embodiment the laser generation system is a sub sea diode laser systems providing laser beams in the 400 nm to 900 nm wavelengths, the 400 s nm, the 500 s nm, and the 600 s nm waive lengths, and having powers of greater than 1 kW, and preferably greater than about 5 kW.

The sub sea laser source, and the sub sea in situ laser source, should preferably have total power of at least about 1 kW, from about 1 kW to about 20 kW, from about 10 kW to about 20 kW, at least about 10 kW, and about 20 or more kW. Moreover, combinations of various lasers may be used to provide the above total power ranges. Further, the laser source may have beam parameters in mm millirad as large as is feasible with respect to bendability and manufacturing the shorter lengths of the fiber used in the present embodiments. In embodiments the beam parameters may be less than about 100 mm millirad, from single mode to about 50 mm millirad, less than about 50 mm millirad, less than about 15 mm millirad, and most preferably about 12 mm millirad. Further, the laser source may have at least a 10% electrical optical efficiency, at least about 50% optical efficiency, at least about 70% optical efficiency, whereby it is understood that greater optical efficiency, all other factors being equal, is preferred, and preferably at least about 25%. The laser source can be run in either pulsed or continuous wave (CW) mode. The laser source may be capable of being fiber coupled.

A single high power sub sea laser may be utilized in embodiments of the sub sea, and sub sea in situ, laser generation systems, or these systems may have two or three high power lasers, or more. The high power lasers for example can be high power solid-state lasers, specifically semiconductor lasers and fiber lasers are preferred, because of their short start up time and essentially instant-on capabilities. The high power lasers for example may be fiber lasers or semiconductor lasers having 10 kW, 20 kW, 50 kW or more power and, which emit laser beams with wavelengths in the range from about 455 nm (nanometers) to about 2100 nm, preferably in the range about 800 nm to about 1600 nm, about 1060 nm to 1080 nm, 1530 nm to 1600 nm, 1800 nm to 2100 nm, and about 1064 nm, about 1070-1080 nm, about 1360 nm, about 1455 nm, 1490 nm, or about 1550 nm, or about 1900 nm (wavelengths in the range of 1900 nm may be provided by Thulium lasers).

In embodiments of the sub sea, and sub sea in situ laser generation system, the high power laser can be a plurality diode lasers (two, ten, tens, a hundred, hundreds or more diodes). In embodiments of the sub sea, and sub sea in situ laser generation system, the high power laser can provide laser beams having an M² of about 200 and greater, less than about 200, less than 90, less, than about 50, less than about 10, and less than about 5, and smaller. In embodiments of the sub sea, and sub sea in situ laser generation system the high power laser has a plurality phase arrayed diode lasers. In embodiments of the sub sea, and sub sea in situ laser generation system the high power laser utilizes high brightness diode lasers. In embodiments of the sub sea, and sub sea in situ laser generation system the laser provides a laser beam having a beam parameter of about 200 mm milliard and greater, less than 200 mm milliard, less than about 100 mm milliard, less than about 50 mm milliard, and smaller.

Management and controlling of the heat generated by sub sea, and in particular sub sea in situ laser beam generation, can be accomplished by waste heat management techniques and systems. Waste heat management, e.g., cooling the laser system can be accomplished by using the reduced temperatures of the ocean or body of water, near the sea floor. In particular, water temperatures can precipitously drop from surface temperatures with depth, for example, and depending on geographic location, water temperature can be about 7-8° C. at 1,000 feet, and continue to become cooler as depth increases below 1,000 feet, to temperatures below 4° C., and below 3° C. at depths of about 10,000 feet. Thus, cool seawater can be used, such as by having a cooling channel in the sub sea component that houses the sub sea in situ laser generation system. Heat exchanger materials or apparatus can be in thermal contact between the cooler deep water and the laser, in this manner the waste heat is conveyed to the cooler deep water, without the requirement of a fluid circulation system. A cooling fluid can also be used, and preferably as a closed loop cooling system that circulates a cooling fluid between the cool deep water and the laser. In this way seawater is not introduced into, and preferably is isolated from, the laser, and the inner parts of the sub sea components.

The cooling fluids, which may be circulated or not flowing, can be N2, air, water, liquid N2, CO2, liquid CO2, liquid propane, glycol, ethylene glycol, propylene glycol, silicone oil, mud, alcohols, HFCs, MCFCs, HCCs, HCs, CFCs, PFCs, HCFOs, Ammonia, Helium, Argon, CFOs, PFOB, HCOs, HFOs, PCCs, and PCOs.

Cooling may also be accomplished by phase cooling, such as by melting a solid (e.g., a wax) having a low melt temperature. For shorter firing, or run times, this method of cooling in some embodiments can avoid the use of a heat exchanger.

Thus, there is for example provided a sub sea hydrocarbon (e.g., oil and gas) exploration and production component, having a cooling system for cooling a sub sea laser generation system. Embodiments of these would would include: a laser shear ram assembly, having an in situ laser generation system and a cooling system, and a shear laser module (“SLM”) having an in situ laser generation system and cooling system.

It is noted that in embodiments the laser housing, e.g., the shear laser module housing, my be at a cool enough temperature when it is deployed sub sea, and have sufficient mass, to itself function as the cooling system. Thus, it would be both the cooling systems and the protective housing. In these embodiments no additional cooling system would be required.

Preferably, the sub sea cooling system is capable of maintaining the temperature of the high power laser below 70° C., at or below 50° C., at or below 40° C. and at or below 20° C. In a preferred embodiment the cooling systems uses the cool deep water as a heat sink, to maintain the high power laser system below the operating diode laser temperature.

Embodiment of the present systems, apparatus and methods that, among other things, provide for the use of a laser source, in sub sea environments to generate and propagate a laser beam sub sea, and preferably, in situ, in a sub sea component. Embodiments of these sub sea laser systems, include for example, a semiconductor laser source, which, for example is an assembly of semiconductor lasers that provides, sub sea, and sub sea, in situ, a laser beam having a wavelength from about 300 nm to about 1,500 nm. Such sub sea, and sub sea in situ laser beams may also have high brightness and high power.

Embodiments of these sub sea semiconductor laser sources, for sub sea and sub sea in situ generation of laser beams, include for example, an assembly of diode lasers, and preferably high brightness diode lasers, that provide a laser beam having a wavelength from 300 nm to 900 nm, having a wavelength from about 455 to about 810 nm, having a wavelength of less than about 900 nm, having a wavelength of less than about 800 nm, having a wavelength in the four-hundreds nm (i.e., 400 nm-499.999 nm, “400 s” nm or “4XX” nm), having a wavelength in the 5XXs nm, and having a wavelength in the 8XXs nm, and also in the 6XXs nm, and 7XXs nm.

Embodiments of these sub sea semiconductor laser sources, and for sub sea and sub sea in situ generation of laser beams, can have one, two three, four, tens, hundreds, and more individual semiconductor lasers, such as for example diode lasers. Embodiments of the individual, or single, laser beams from these semiconductor lasers can have BPP of less than 1,000 mm mrad (i.e., milliard), BPP of less than 500 mm mrad (i.e., milliard) BPP of less than 100 mm mrad (i.e., milliard), BPP of less than 50 mm mrad (i.e., milliard), less than 20 mm rad, less than 15 mm mrad, less than 10 mm mrad, less than 8 mm mrad, and less than 3 mm mrad. The individual, or single, laser beams from these semiconductor lasers can have an M² of less than about 200, an M² of less about 100, an M² of 50 or less, an M² of 3 or less, an M² of 2 or less, an M² of 1.5 or less, and an M² of 1.1 or less. The individual, or single, laser beams from these semiconductor lasers can have a power of at least about 1 W, at least about 10 W, at least about 100 W, and at least about 1,000 W.

Embodiments of these sub sea semiconductor laser sources, for sub sea, and sub sea in situ generation of laser beams, can have one, two three, four, tens, hundreds, and more individual semiconductor lasers, such as for example diode lasers.

In embodiments of the sub sea semiconductor laser sources, these individual initial laser beams are combined sub sea, and sub sea in situ, with a sub sea and sub sea in situ beam combination, to form an operational laser beam. An “initial sub sea laser beam” or “initial laser beam”, “beam let” or “initial beam” is the first laser beam that is generated sub sea by a sub sea laser. An “operational laser beam” or “operational beam” is a sub sea laser beam that has sufficient power to perform an intended laser operation and is directed along a laser beam path at a sub sea target to perform the intended laser operation. Although a single operational laser beam can be used, in embodiments of some applications one, two, three or more operational laser beams may be utilized and may be preferred.

The one, two, three, tens, or thousands of initial laser beams can be combined sub sea and sub sea in situ. Thus, sub sea, and sub sea in situ, beam combiners, beam combining assemblies and beam combining systems are contemplated in embodiments in laser BOPS, sub sea laser cutting assemblies, and sub sea laser assemblies and operations.

Laser systems, initial laser beam sources, beam combiners, and systems and methods for combining initial laser beams from initial laser beam sources are disclosed and taught in U.S. patent application Ser. No. 14/958,864 and 62/266,509 the entire disclosures of each of which are incorporated herein by reference.

Further, it should be noted that not all of the initial sub sea laser beams need to be combined into an operation laser beam. Thus, one, two, three or more of the initial sub sea laser beams can be used for applications other than performing a laser operation on a target, such other applications would include for example, monitoring, communications, or analysis. Additionally, it should be noted that a single initial laser beam may have sufficient power to function as an operational laser beam, and if utilized as such, would then be considered both an initial laser beam and an operation laser beam.

Embodiments of the operational laser beam, preferably have powers that are 1 kW and greater, 2 kW and greater, 10 kW and greater, 15 kW and greater, and 20 kW and greater. Embodiments of the operational laser beam preferably have high brightness and exceptionally high brightness (i.e., BPP of less than 10 mm mrad, M² of less than 1.5, or both). Embodiments of the operational laser beam preferably have BPP of 200 mm mrad or less, BPP of 100 mm mrad or less, 50 mm mrad or less, 15 mm mrad or less, 10 mm mrad or less, 8 mm mrad or less, and 3 mm mrad or less. Embodiments of the operational laser beam preferably have an M² of 1,000 or less, M² of 500 or less, M² of 200 or less, M² of 100 or less, M² of 50 or less, M² of 20 or less, M² of 10 or less, an M² of 5 or less, an M² of 3 or less, an M² of 2 or less, an M² of 1.5 or less, and an M² of 1.2 or less.

Embodiments of sub sea semiconductor laser sources, for sub sea and sub sea in situ generation of laser beams, can increase the power of the initial laser beam while preserving brightness, more preferably, these laser sources can significantly increase operational laser beam power, with minimal effects on brightness. Thus, for example, the laser assemblies or systems (e.g., laser sources) can increase the power of the initial laser beam by at least 10×, by at least 100×, and by at least 1000× or more through sub sea and sub sea in situ beam combination. The laser sources can preserve brightness of the initial laser beams by having less than a 10% increase in M², less than a 20% increase in M², less than a 50% increase in M², and less than a 100% increase in M² from the in situ beam combination.

The high power laser may also be located near the laser tool, such as for example, when the tool and laser are associated with a remote operated vehicle (“ROV”) or a laser PIG. In these embodiments the laser tools and assemblies can be located within the ROV, the ROV support structure, or can be in a laser tool, that is held or controlled by for example the ROV's manipulator arm. Laser ROVs and sub-sea laser operations are disclosed and taught in U.S. Pat. No. 9,080,425 the entire disclosure of which is incorporated herein by reference.

The sub sea laser may be any high powered laser that is capable of providing sufficient energy to perform the desired functions. The laser source can be for example a single mode laser or low order multi-mode laser with a low M² to facilitate launching into a small core optical fiber, i.e. about 50 microns. Examples of a laser source include fiber lasers, chemical lasers, disk lasers, thin slab lasers, high brightness diode lasers, as well as, the spectral beam combination of these laser sources or a coherent phased array laser of these sources to increase the brightness of the individual laser source.

The sub sea laser source may be a low order mode source (M²<2) so it can be focused into an optical fiber with a core/mode diameter of <100 microns. Optical fibers with small core/mode field diameters ranging from 50 microns to 6 microns have the lowest transmission losses.

Thus, the sub sea laser source should have total power of at least about 1 kW, from about 1 kW to about 20 kW, from about 10 kW to about 20 kW, at least about 10 kW, and preferably about 20 or more kW. Moreover, combinations of various lasers may be used to provide the above total power ranges. Further, the laser source may have beam parameters in mm mrad as large as is feasible with respect to bendability and manufacturing the lengths of the fiber, contemplated in the present embodiments, thus the beam parameters may be less than about 100 mm mrad, from single mode to about 50 mm mrad, less than about 50 mm mrad, less than about 15 mm mrad, and most preferably about 12 mm mrad. Further, the laser source may have at least a 10% electrical optical efficiency, at least about 50% optical efficiency, at least about 70% optical efficiency, whereby it is understood that greater optical efficiency, all other factors being equal, is preferred, and preferably at least about 25%. The laser source can be run in either pulsed or continuous wave (CW) mode. The laser source may be capable of being fiber coupled.

Thus by way of example, the sub sea laser may be a solid-state laser, it may be a gas, chemical, dye or metal-vapor laser, or it may be a semiconductor laser. Further, the laser may produce a kilowatt level laser beam, and it may be a pulsed laser. The laser further may be a Nd:YAG laser, a CO₂ laser, a diode laser, such as an visible diode laser or an IR diode laser, or a fiber laser, such as a ytterbium-doped multi-clad fiber laser, Raman Cascade laser based on fiber crystal, diamond or an undoped YAG. The fiber for the fiber laser is doped with an active gain medium comprising rare earth elements, such as holmium, erbium, ytterbium, neodymium, dysprosium, praseodymium, thulium or combinations thereof. Combinations of one or more types of lasers may be implemented.

A single high power sub sea laser may be utilized in the system, or the system may have two or three high power lasers, or more. High power solid-state lasers, specifically semiconductor lasers and fiber lasers can be used, because of their short start up time and essentially instant-on capabilities. The high power lasers for example may be fiber lasers or semiconductor lasers, and laser arrays, having 10 kW, 20 kW, 50 kW or more power and, which emit laser beams with wavelengths in the range from about 300 nm (nanometers) to about 2100 nm.

Embodiments of the sub sea, and sub sea in situ, laser systems and methods of generating laser beams, may generally include one or more features to protect the laser. This becomes important because of the harsh sub sea environments, and in particular for greater depths, e.g., greater than 1,000 feet, greater than 5,000 feet, and at about 10,000 feet and greater. Thus, in accordance with one or more embodiments, a sub sea laser system may include a cooling system. The cooling system may generally function to cool the laser. For example, the cooling system may cool a sub sea laser, for example to a temperature below the ambient temperature or to an operating temperature, e.g., the preferred or recommended operating temperature, of the laser. Further, the laser may be cooled using sorption cooling to the operating temperature of the diode laser, for example, for an infrared diode laser about 20° C. to about 100° C. For a fiber laser its operating temperature may be between about 20° C. to about 50° C. A liquid at a lower temperature may be used for cooling when a temperature higher than the operating diode laser temperature is reached to cool the laser.

A pressure containment housing or assembly may be used to contain and protect the laser source, e.g., the laser generation assembly, and could also contain, e.g., house, the power source, e.g., a generator or battery. The pressure containment housing preferably utilizes technology and features that are typically used for ROVs, submarines, diving equipment, and other sub sea structures to house and protect electron or mechanical components from pressure and the adverse effects of seawater, and the sub sea environment. Such components and technologies, as well as newly developed components and technologies, preferably are used to house and protect the laser, cooling system, power source, and other components associate with the laser generation system. As discussed above the protective housing can be the structure of a sub sea component, such as a ram shear.

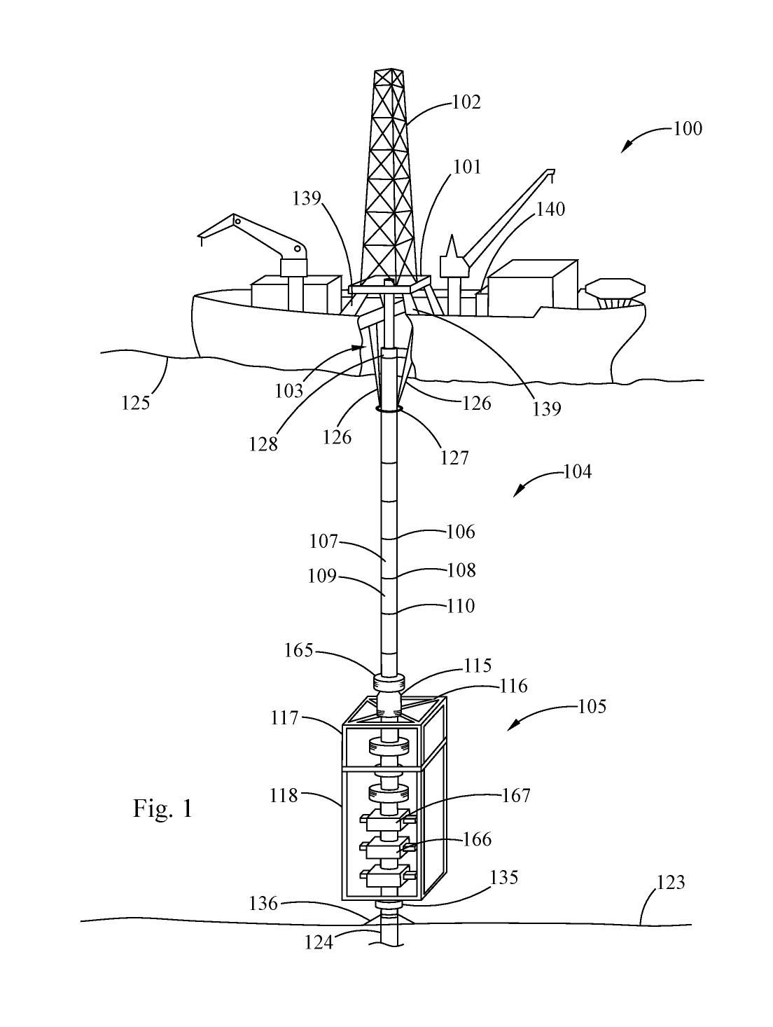

Thus, by way of example, an embodiment of an offshore drilling rig having a laser beam delivery system is schematically shown in FIG. 1. In this embodiment there is provided a dynamically positioned (DP) drill ship 100 having a drill floor 101, a derrick 102 above the drill floor, and moon pool 103 (as seen by the cutaway in the figure showing the interior of the drill ship 100) below the drill floor 101 and other drilling and drilling support equipment and devices utilized for operation, which are known to the offshore drilling arts, but are not shown in the figure. The drill ship includes a riser 104 and a BOP stack 105. Although a drill ship is shown in this embodiment, any other type of offshore drilling rig, vessel or platform, including FPSOs, and FGSOs, may be utilized.

The riser 104 is deployed and connects drill ship 100 with a borehole 124 that extends below the seafloor 123. The upper portion, i.e., the portion of the riser when deployed that is closest to the surface 125 of the water, of riser 104, is connected to the drillship 100 by tensioners 126 that are attached to tension ring 127. The upper section of riser 104 may have a diverter 128 and other components (not shown in this figure) that are commonly utilized and employed with risers and are well known to those of skill in the art of offshore drilling.

The riser 104 extends from the moon pool 103 of drill ship 100 and is connected to BOP stack 105. The riser 104 is made up of riser sections, e.g., 107, 109, that are connected together, by riser couplings, e.g., 106, 108, 110 and lowered through the moon pool 103 of the drill ship 100. Thus, the riser 104 may also be referred to as a riser string. The lower portion, i.e., the portion of the riser that when deployed is closest to the seafloor, of the riser 104 is connected to the BOP stack 105 by way of the riser-BOP connecter 115. The riser-BOP connecter 115 is associated with flex joint 116, which may also be referred to as a flex connection or ball joint. The flex joint 116 is intended to accommodate movements of the drill ship 100 from positions that are not directly above the laser assisted BOP stack 105; and thus accommodate the riser 104 coming into the BOP stack 105 at an angle.

The BOP stack 105 may be characterized as having two component assemblies: an upper component assembly 117, which may be referred to as the lower marine riser package (LMRP), and a lower component assembly 118, which may be referred to as the lower BOP stack or the BOP proper. The BOP stack 105 has a wellhead connecter 135 that attached to wellhead 136, which is attached to borehole 124. The LMRP 117 of the BOP stack 105 may have a frame that houses for example an annular preventer. The lower component assembly 118 the BOP 105 may have a frame that houses an annular preventer, a laser shear ram assembly, a shear laser module (“SLM”) and a ram preventer.

During deployment the BOP stack 105 is attached to the riser 104, lowered to the seafloor 123 and secured to a wellhead 136. The wellhead 136 is position and fixed to a casing (not shown), which has been cemented into a borehole 124. From this point forward, generally, all the drilling activity in the borehole takes place through the riser and the BOP. Such drilling activity would include, for example, lowering a string of drill pipe having a drill bit at its end from the drill ship 100 down the internal cavity of the riser 104, through the cavity of the BOP stack 105 and into the borehole 124. Thus, the drill string would run from the drill ship 100 on the surface 125 of the water to the bottom of the borehole, potentially many tens of thousands of feet below the water surface 125 and seafloor 123. The drill bit would be rotated against the bottom of the borehole, while drilling mud is pumped down the interior of the drill pipe and out the drill bit. The drilling mud would carry the cuttings, e.g., borehole material removed by the rotating bit, up the annulus between the borehole wall and the outer diameter of the drill string, continuing up through the annulus between BOP cavity wall and the outer diameter of the drill string, and continuing up through the annulus between the inner diameter of the riser cavity and the outer diameter of the drill string, until the drilling mud and cuttings are directed, generally by a bell housing (not shown), or in extreme situations a diverter 128, to the drill ship 100 for handling or processing. Thus, the drilling mud is pumped from the drill ship 100 through a drill string in the riser to the bottom of the borehole and returned to the drill ship, in part, by the riser 104 and BOP 105.

The sections of the riser are typically stored vertically on the offshore drilling rig. Once the drilling rig has reached a drilling location the riser and BOP package are deployed to the seafloor. In general, it being recognized that different, varied and more detailed procedures may be followed, as a first step in deploying the BOP, the BOP stack is prepared and positioned under the drill floor and under the rotary table. A spider and gimbal are also positioned with respect to the rotary table. The lower most section of the riser that attaches to the BOP is moved into the derrick and lowered by the hoisting apparatus in the derrick through the spider and down to the BOP below the drill floor where it is connected to the BOP. The riser and BOP are then lowered to a point where the upper coupling of the riser section is at a height above the drill floor were it can be readily connected to the next section of riser. The spider holds the riser in this position. Once the connection has been made, the two sections and the BOP are then lowered, and this process is repeated until sufficient sections of riser have been added and lowered to enable the BOP to reach and be landed on (attached to) the wellhead at the seafloor.

During this process, laser cutters can be attached to the riser either below the drill floor, if they are too large to fit through the spider, or above the drill floor if they can fit through the spider. Additionally, during the assembly of the BOP laser cutters can be attached, or placed in the stack as assembled. The laser cutters could also be contained within the stack and within a riser section and thus, not require any additional assembly time or time to affix the cuter during deployment of the riser and BOP.

The riser has an internal cavity, not shown in FIG. 1 that is in fluid and mechanical communication with an internal cavity, not shown in FIG. 1, in the BOP stack. Thus, as deployed, the riser 104 and BOP 105 provide a cavity or channel putting the drillship in fluid and mechanical communication with the borehole 124. The BOP stack frames protect the BOP, and may have lifting and handling devices, a control and connection module, and other equipment and devices utilized in subsea operation, which are known to the offshore drilling art, but are not shown in the figure. The internal cavity in the stack goes through the stack from its top (closest to the water surface 125) to its bottom (closest to the sea floor 123).

In the exemplary embodiment shown in FIG. 1 the riser is a 21″ riser and the BOP is an 18¾″ BOP. The term “21″ riser” and 18¾″ BOP can be considered as generic and cover risers wherein the large central tube has an outer diameter in the general range of 21″ and BOPS where the center cavity or bore diameter is in the general range of 18¾″. The use of smaller and larger diameter risers, different types and configurations of risers, BOPS having smaller and larger diameter cavities, and different types and configurations of BOPS, are contemplated; and, the teachings and inventions of this specification are not limited to, or by, the size, type or configuration of a particular riser or BOP.

In FIG. 1 the riser and BOP package is configured along the lines of a drilling riser BOP package with the BOP positioned at or near the seafloor, typically attached to a wellhead, as for example seen in some drilling activities. The present systems, laser modules, laser cutters laser assemblies and laser-riser assemblies of the present inventions have applications to other types of risers, riser-BOP packages and activities and sub sea oil and gas production fields, as well as non-oil and gas applications. Thus, they have applications in relation to drilling, workover, servicing, testing, intervention and completing activities. They also have applications to surface BOPS, e.g., where BOP is positioned above the surface of the water and the riser extends from the BOP to the seafloor, where a BOP is not employed, were drilling is done in the riser, where the riser is a production riser, and other configurations known to or later developed by the art.

Several sub sea, laser beam delivery systems are in the embodiment shown in FIG. 1. The control room 140 contains monitoring and control equipment, e.g., controllers, PLCs, computers, that monitor and operate, and monitor the operation of the subsea laser systems. The control room 140 may be connected to the sub sea laser system by communication and data cables. The control room 140, may be a part of, or integral with the BOP control system and may be collocated with the monitors and controls for that system.

The sub sea laser assembly may also have its own control and monitoring equipment, thus providing the capability for autonomous, e.g., automatic, operation in the event that certain conditions are detected requiring the firing of the sub sea laser to perform a sub sea laser operation. And these sub sea laser assemblies may be in control communications with each other and with the control room 140 on the surface.

There is also shown a deck 137 of the drill ship 100 that is below the rig floor 101, and another deck 138 of the drill ship 100 that is below deck 137. Supports 139 for the drill floor 101 and derrick 102 are also shown.

A sub sea laser and laser cutter assembly 165 is associated with the riser 104 and provided to assist in the quick disconnection of the riser. A sub sea laser and laser cutter assembly 166 is associated with the cavity of the BOP 105 and provided to assist in the quick disconnection of any tubular that is within the BOP cavity. A sub sea, in situ, laser and laser cutter assembly 167 is contained within a shear ram and provided to assist the shear ram in quickly severing any tubular in the path of the rams and sealing the BOP bore.

Although three sub sea laser and laser cutters assemblies are shown, more or less may be employed. Further the positions of these sub sea assemblies with respect to the riser-BOP package components many be varied, and may also vary depending upon the particular components that are employed in the riser-BOP package. An advantage of the present system is that its components can be tailored to match a particular BOP or riser-BOP package configuration. A further advantage the present inventions is that the preselected laser firing and preventer activation sequences can be tailored to match these configurations, as well as, the applications in which these configuration may be used.

The control room, e.g., 140, may be modular, that is, the room may be a self-contained unit such as a container used for shipping that has been fitted with electrical, communication and optical fittings. In this case, it is also preferable that the container has climate control features, e.g., heaters and air conditioners, built in or otherwise incorporated into the room. The control room could be a structure that is integral to the offshore drilling rig, or it could be a combination of modular components and integral components. Any such structure will suffice and any placement, including on a separate laser boat from the offshore drilling rig can be employed, provided that the laser equipment and operators are sufficiently protected from the offshore environmental and operating conditions, and that the laser system is readily capable of being integrated into, or with, the other systems of the offshore drilling rig.

The controller in the laser control room, in the sub sea laser assemblies, and both, may be any type of processor, computer, programmed logic controller (PLC), or similar computer device having memory and a processor; that may be, or is, used for industrial, marine or factory automation and control. In the system, the controller preferably should be in data and control communication with the offshore drilling rig's equipment, in particular the BOP control systems. Although show as being in a separate room in the figures, the laser system controller could be integral with, or the same as, the BOP controller, or another controller or control system of the offshore drilling rig.

The laser system controller and monitors (both sub sea and surface) may also be in communication with, integral with, or in association with, downhole sensing and monitoring equipment, rig floor sensing and monitoring equipment and mud return sensing and monitoring equipment. In this manner the laser system is integral with, or preferably, fully integrated into the BOP control systems and other systems on the offshore drilling rig. Further, the controller may be a part of a control network that includes the BOP control system, monitors and sensors for downhole conditions, drilling systems controllers and monitors and other systems of the offshore drilling rig. Thus, in a potential emergency situation, or an actual emergency situation, the laser cutters and BOP preferably can be controlled from the BOP control panel, the control room, the drilling console, or other locations in the offshore drilling rig. This fully integrated control system network, may further have predetermined laser firing, preventer actuation and kill, choke and boost pumping and control procedures that could be automatically activated and run upon an a predetermined command being sent to or entered into the network. Moreover, the network upon detecting a specific set of conditions may initiate a predetermined command being sent and causing a predetermined laser firing, preventer actuation, and kill and choke and sequence.

Embodiments of the sub sea laser systems and assemblies of the present invention may be utilized in conjunction with a surface based high power laser system, having one, two or three high power lasers, and may have several high power lasers, for example, six or more. The laser, or lasers, may be located on the offshore drilling rig, above the surface of the water, and optically connected to sub sea laser modules or laser cutters by way of a high power long distance laser transmission cable(s). The laser transmission cable may be contained on a spool and unwound and attached to the riser sections as they are lowered to the seafloor. Embodiments of these types of laser systems are taught and disclosed in U.S. Pat. Nos. 8,783,361, 8,684,088, 8,720,575, 7,783,369 and 8,720,584, the entire disclosure of each of which is incorporated herein by reference.

The laser cutters used in the laser systems of the present inventions may be any suitable device for the delivery of high power laser energy. Embodiments of such laser cutters and laser assemblies are disclosed and taught in U.S. Pat. Nos. 8,783,361, 8,684,088, and 8,783,360, the entire disclosure of each of which is incorporated herein by reference. Any configuration of optical elements for culminating and focusing the laser beam can be employed. A further consideration, however, is the management of the optical effects of fluids, e.g., sea water, mud or other material from a cut choke line, cut kill line or cut center tube of a riser, or hydraulic fluid from a cut hydraulic line, that may be located within the beam path between laser cutter and the object to be cut, such as a tubular, a riser, coupling, center pipe, external pipe, bolt, nut or other structure to be cut. Embodiments of the sub sea, and sub sea in situ, laser system, address this consideration by having a predetermined wavelength for the laser beam, where the wavelength is selected to preferably provide optimal performance (e.g., minimize or reduce power loses from the laser beam interaction with the fluid), matching the fluid optical properties to a preselected laser beam wavelength (to preferably optimize performance) and both of these approaches.

These fluids could include, by way of example, water, seawater, salt water, brine, drilling mud, nitrogen, inert gas, diesel, mist, foam, or hydrocarbons. There can also likely be present in these drilling fluids borehole cuttings, e.g., debris, which are being removed from, or created by, the advancement of the borehole or other downhole operations. There can be present two-phase fluids and three-phase fluids, which would constitute mixtures of two or three different types of material. These riser fluids can interfere with the ability of the laser beam to cut the tubular, or other structure to be cut. Such fluids may not transmit, or may only partially transmit, the laser beam, and thus, interfere with, or reduce the power of, the laser beam when the laser beam is passed through them. If these fluids are flowing, such flow may further increase their non-transmissiveness. The non-transmissiveness and partial-transmissiveness of these fluids can result from several phenomena, including without limitation, absorption, refraction and scattering. Further, the non-transmissiveness and partial-transmissiveness can be, and likely will be, dependent upon the wavelength of the laser beam. Thus, embodiments of the present systems have predetermined and preselected laser beam wavelengths, fluids, and both, to avoid, minimize and address these phenomena.

Depending upon the configuration of the laser cutters, the riser and the BOP package, the laser beam could be required to pass through over about 8″ of riser fluids. In other configurations the laser cutters may be positioned in close, or very close, proximity to the structure to be cut and moved in a manner where this close proximity is maintained. In these configurations the distance for the laser beam to travel between the laser cutters and the structure to be cut may be maintained within about 2″, less than about 2″, less than about 1″ and less than about ½″, and maintained within the ranges of less than about 3″ to less than about ½″, and less than about 2″ to less than about ½″.

In particular, for those configurations and embodiments where the laser has a relatively long distance to travel, e.g., greater than about 1″ or 2″ (although this distance could be more or less depending upon laser power, wavelength and type of drilling fluid, as well as, other factors) it is advantageous to minimize the detrimental effects of such riser fluids and to substantially ensure, or ensure, that such fluids do not interfere with the transmission of the laser beam, or that sufficient laser power is used to overcome any losses that may occur from transmitting the laser beam through such fluids. To this end, mechanical, pressure and jet type systems may also be utilized, sub sea laser systems having preselected wavelengths, to reduce, minimize or substantially eliminate the effect of the drilling fluids on the laser beam.

For example, mechanical devices may be used to isolate the area where the laser cut is to be performed and the riser fluid removed from this area of isolation, by way of example, through the insertion of an inert gas, or an optically transmissive fluid, such as an oil or diesel fuel. The use of a fluid in this configuration has the added advantage that it is essentially incompressible. Moreover, a mechanical snorkel like device, or tube, which is filled with an optically transmissive fluid (gas or liquid) may be extended between or otherwise placed in the area between the laser cutter and the structure to be cut. In this manner the laser beam is transmitted through the snorkel or tube to the structure.

A jet of high-pressure gas may be used with the laser cutter and laser beam. The high-pressure gas jet may be used to clear a path, or partial path for the laser beam. The gas may be inert, or it may be air, oxygen, or other type of gas that accelerates the laser cutting. The relatively small amount of oxygen needed, and the rapid rate at which it would be consumed by the burning of the tubular through the laser-metal-oxygen interaction, should not present a fire hazard or risk to the drilling rig, surface equipment, personnel, or subsea components.

The use of oxygen, air, or the use of very high power laser beams, e.g., greater than about 1 kW, could create and maintain a plasma bubble or a gas bubble in the cutting area, which could partially or completely displace the drilling fluid in the path of the laser beam.

A high-pressure laser liquid jet, having a single liquid stream, may be used with the laser cutter and laser beam. The liquid used for the jet should be transmissive, or at least substantially transmissive, to the laser beam. In this type of jet laser beam combination the laser beam may be coaxial with the jet. This configuration, however, has the disadvantage and problem that the fluid jet does not act as a wave-guide. A further disadvantage and problem with this single jet configuration is that the jet must provide both the force to keep the drilling fluid away from the laser beam and be the medium for transmitting the beam.

A compound fluid laser jet may be used as a laser cutter. The compound fluid jet has an inner core jet that is surrounded by annular outer jets.

The laser beam is directed by optics into the core jet and transmitted by the core jet, which functions as a waveguide. A single annular jet can surround the core, or a plurality of nested annular jets can be employed. As such, the compound fluid jet has a core jet. This core jet is surrounded by a first annular jet. This first annular jet can also be surrounded by a second annular jet; and the second annular jet can be surrounded by a third annular jet, which can be surrounded by additional annular jets. The outer annular jets function to protect the inner core jet from the drill fluid present in the annulus between the laser cutter and the structure to be cut. The core jet and the first annular jet should be made from fluids that have different indices of refraction. In the situation where the compound jet has only a core and an annular jet surrounding the core the index of refraction of the fluid making up the core should be greater than the index of refraction of the fluid making up the annular jet. In this way, the difference in indices of refraction enable the core of the compound fluid jet to function as a waveguide, keeping the laser beam contained within the core jet and transmitting the laser beam in the core jet. Further, in this configuration the laser beam does not appreciably, if at all, leave the core jet and enter the annular jet.

The pressure and the speed of the various jets that make up the compound fluid jet can vary depending upon the applications and use environment. Thus, by way of example the pressure can range from about 3000 psi, to about 4000 psi to about 30,000 psi, to preferably about 70,000 psi, to greater pressures. The core jet and the annular jet(s) may be the same pressure, or different pressures, the core jet may be higher pressure or the annular jets may be higher pressure. Preferably the core jet is higher pressure than the annular jet. By way of example, in a multi-jet configuration the core jet could be 70,000 psi, the second annular jet (which is positioned adjacent the core and the third annular jet) could be 60,000 psi and the third (outer, which is positioned adjacent the second annular jet and is in contact with the work environment medium) annular jet could be 50,000 psi. The speed of the jets can be the same or different. Thus, the speed of the core can be greater than the speed of the annular jet, the speed of the annular jet can be greater than the speed of the core jet and the speeds of multiple annular jets can be different or the same. The speeds of the core jet and the annular jet can be selected, such that the core jet does contact the drilling fluid, or such contact is minimized. The speeds of the jet can range from relatively slow to very fast and preferably range from about 1 m/s (meters/second) to about 50 m/s, to about 200 m/s, to about 300 m/s and greater The order in which the jets are first formed can be the core jet first, followed by the annular rings, the annular ring jet first followed by the core, or the core jet and the annular ring being formed simultaneously. To minimize, or eliminate, the interaction of the core with the drilling fluid, the annular jet is created first followed by the core jet.

In the preferred embodiments of the sub sea laser systems and assemblies the operational laser beam wavelength is selected to have low, minimal, and preferably de m inimis absorption by the fluids likely to be present in the cavity, in the fluid jet, and both. In embodiments of the sub sea laser systems and assemblies the fluid may be selected based upon its optical properties for the predetermined laser beam to have low, minimal, and preferably de minimis absorption of the laser beam. In embodiments of the sub sea laser systems and assemblies both the laser beam wavelength and the fluid optical properties may be selected, and preferably matched, to optimize the performance of the laser beam, e.g., reduce loses during transmission through the fluid, among other things.

In an embodiment of the sub sea laser systems and assemblies, including semiconductor laser sources, for sub sea, and sub sea in situ generation of laser beams having an operation laser beam having at least about 5 kW of power, at least about 10 kW of power, and preferably 20 kW or more of power, and a wavelength selected from the range of 455 nm to about 810 nm, and the fluid present in the pressure containment cavity (e.g., the BOP cavity) has an absorptivity for the laser beam of the preselected wavelength in this range of less than 0.001 1/cm, of less than about 0.01 1/cm; of less than about 0.1 1/cm; and of less then about about 1 1/cm. In an embodiment the preselected wavelength is in the 400 s nm, the 500 s nm, and the fluid is at least 50% water or more.

In an embodiment of the sub sea laser systems and assemblies, including semiconductor laser sources, for sub sea, and sub sea in situ generation of laser beams having an operation laser beam having at least about 5 kW of power, at least about 10 kW of power, and preferably 20 kW or more of power, and a wavelength selected from the range of 455 nm to about 810 nm, and the fluid present in the fluid laser jet has an absorptivity for the laser beam of the preselected wavelength in this range of less than 0.001 1/cm, of less than about 0.01 1/cm; of less than about 0.1 1/cm; and of less then about about 1 1/cm.

In an embodiment the preselected wavelength is in the 400 s nm, the 500 s nm, and the fluid in the containment vessel is at least 50% water, at least 75% water, and at least 90% water. In an embodiment the preselected wavelength is in the 400 s nm, the 500 s nm, and the fluid in the fluid laser jet is at least 50% water or more. In an embodiment both the fluid in the fluid laser jet and in the pressure containment cavity have at least about 50% water.

In an embodiment of the sub sea laser systems and assemblies, including semiconductor laser sources, for sub sea, and sub sea in situ generation of laser beams having an operation laser beam having at least about 5 kW of power, at least about 10 kW of power, and preferably 20 kW or more of power, and a wavelength selected from the range of 400 nm to about 900 nm, and the fluid present in the pressure containment cavity (e.g., the BOP cavity) has an absorptivity for the laser beam of the preselected wavelength in this range of less than 0.001 1/cm, of less than about 0.01 1/cm; of less than about 0.1 1/cm; and of less then about about 1 1/cm. In an embodiment the preselected wavelength is in the 400 s nm, the 500 s nm, and the fluid is at least 50% water or more.

In an embodiment of the sub sea laser systems and assemblies, including semiconductor laser sources, for sub sea, and sub sea in situ generation of laser beams having an operation laser beam having at least about 5 kW of power, at least about 10 kW of power, and preferably 20 kW or more of power, and a wavelength selected from the range of 400 nm to about 900 nm, and the fluid present in the fluid laser jet has an absorptivity for the laser beam of the preselected wavelength in this range of less than 0.001 1/cm, of less than about 0.01 1/cm; of less than about 0.1 1/cm; and of less then about about 1 1/cm.

In an embodiment of the sub sea laser systems and assemblies, including semiconductor laser sources, for sub sea, and sub sea in situ generation of laser beams having an operation laser beam having at least about 5 kW of power, at least about 10 kW of power, and preferably 20 kW or more of power, and a wavelength selected from the range of 400 nm to about 1,500 nm, and the fluid present in the pressure containment cavity (e.g., the BOP cavity) has an absorptivity for the laser beam of the preselected wavelength in this range of less than 0.001 1/cm, of less than about 0.01 1/cm; of less than about 0.1 1/cm; and of less then about about 1 1/cm. In an embodiment the preselected wavelength is in the 400 s nm, the 500 s nm, and the fluid is at least 50% water or more.

In an embodiment of the sub sea laser systems and assemblies, including semiconductor laser sources, for sub sea, and sub sea in situ generation of laser beams having an operation laser beam having at least about 5 kW of power, at least about 10 kW of power, and preferably 20 kW or more of power, and a wavelength selected from the range of 400 nm to about 1,500 nm, and the fluid present in the fluid laser jet has an absorptivity for the laser beam of the preselected wavelength in this range of less than 0.001 1/cm, of less than about 0.01 1/cm; of less than about 0.1 1/cm; and of less then about about 1 1/cm.

In addition to the use of high power laser beams to cut the tubulars, and other sub sea structures, and in particular structure in a containment vessel, other forms of directed energy or means to provide the same, may be generated and utilized sub sea, and sub sea in situ, for example in the BOP stack. Such directed energy means would include plasma cutters, arc cutters, high power water jets, inductive heating, inductive melting, and particle water jets. Each of these means, however, has disadvantages when compared to high power laser energy. In particular, high power laser energy has greater control, reliability and is substantially potentially less damaging to the BOP system components than are these other means. Nevertheless, the use of these others less desirable means is contemplated herein by the present inventions as a directed energy means that is generated sub sea, including sub sea in situ, to cut tubulars and other structures within a pressure containment cavity, such as a BOP cavity.

The angle at which the laser beam contacts the structure to be cut may be determined by the optics within the laser cutter or it may be determined by the angle or positioning of the laser cutter itself. Various angles that are advantageous to or based upon the configuration of the riser, external pipe, coupling or combinations thereof may be utilized.

The number of laser cutters utilized in a configuration of the present inventions can be a single cutter, two cutters, three cutters, and up to and including 12 or more cutters in a single laser cutter assembly, or module. As discussed above, the number of cutters depends upon several factors and the optimal number of cutters for any particular configuration and end use may be determined based upon the end use requirements and the disclosures and teachings provided in this specification. The cutters may further be positioned such that their respective laser beam paths are parallel, or at least non-intersecting within the center axis of the subsea component they are associated with e.g., a riser, a riser cavity, and a BOP cavity to name a few.

The laser cutters have a discharge end from which the laser beam is propagated. The laser cutters also have a beam path. The beam path is defined by the path that the laser beam is intended to take, and extends from the discharge end of the laser cutter to the material or area to be cut.

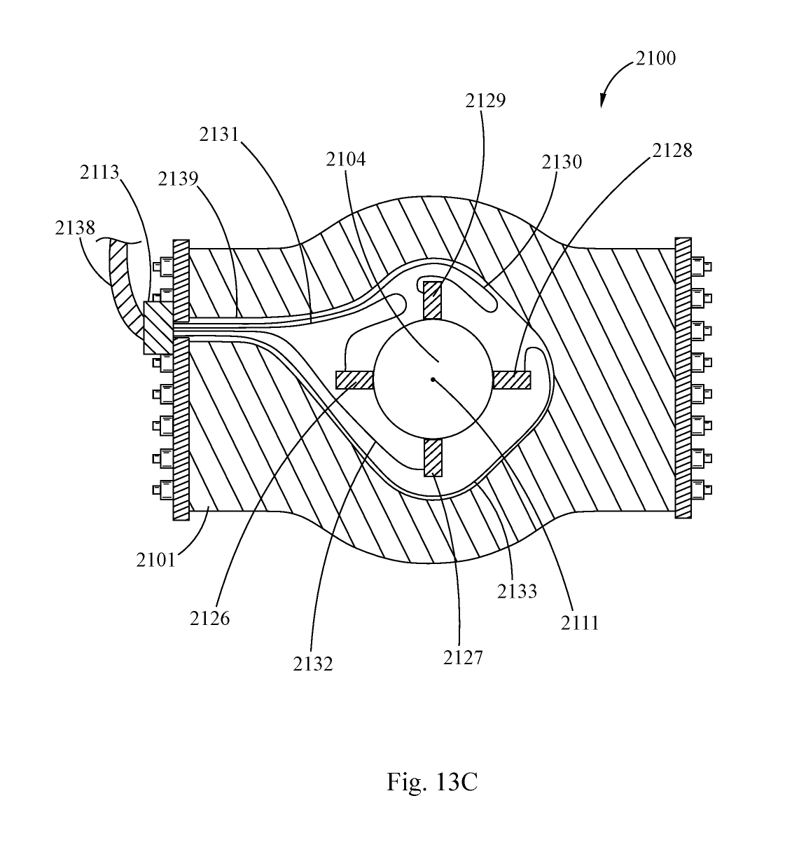

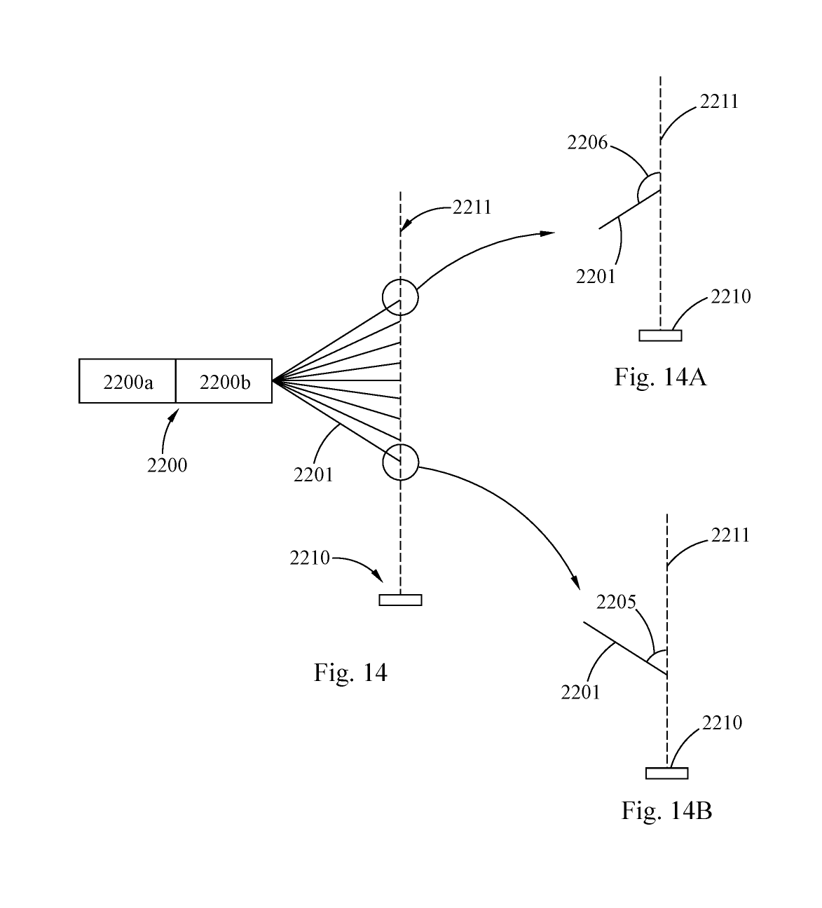

The angle at which the laser beam contacts a tubular may be determined by the optics within the laser cutter or it may be determined by the angle or positioning of the laser cutter itself. In FIG. 14 there is shown a schematic representation of a sub sea laser 2200a (including a semiconductor laser source) and a sub sea cutter 2200b in a sub sea laser assembly 2200 with a beam path 2201 leaving the cutter at various angles. When fired or shot from the laser cutter, a laser beam would travel along a beam path. The beam path is further shown in relation to the BOP cavity or a riser cavity vertical axis (dashed line) 2211. As seen in the enlarged views of FIGS. 14A and 14B, the angle that the beam path 2201 forms with vertical axis 2211, and thus the angle that a laser beam traveling along this beam path forms with vertical axis 2211, can be an acute angle 2205 or an obtuse angle 2206 relative to the portion of the axis 2211 furthest away from the wellhead connection side 2210. A normal or 90° angle may also be utilized. The BOP wellhead connection side 2210 is shown in the Figures as a reference point for the angle determinations used herein.

The angle between the beam path (and a laser beam traveling along that beam path) and the vertical axis of either the BOP or riser, corresponds generally to the angle at which the beam path and the laser beam will strike a tubular that is present in the BOP cavity or the riser. However, using a reference point that is based upon the BOP or the riser to determine the angle is preferred, because tubulars may shift or in the case of joints, or a damaged tubular, present a surface that has varying planes that are not parallel to the BOP cavity center axis; similarly the riser will rarely be straight and may have bends or movements in it.

Because the angle formed between the laser beam and the vertical axis can vary, and be predetermined, the laser cutter's position, or more specifically the point where the laser beam leaves the cutter does not necessarily have to be normal to the area to be cut. Thus, the laser cutter position or the beam launch angle can be such that the laser beam travels from: above the area to be cut, which would result in an acute angle being formed between the laser beam and the vertical axis; the same level as the area to be cut, which would result in a 90° angle being formed between the laser beam and the vertical axis; or, below the area to be cut, which would result in an obtuse angle being formed between the laser beam and the cavity vertical axis. In this way, the relationship between the shape of the rams, the surfaces of the rams, the forces the rams exert, and the location of the area to be cut by the laser can be evaluated and refined to optimize the relationship of these factors for a particular application.

For embodiments where the sub sea laser, the power source for the laser, and both are near but a distance from the cutters, the laser or both the flexible support cables for the laser cutters provide the power, the laser beam and other materials that are needed to perform the cutting operation to the cutters. Although shown as a single cable for each laser assembly, multiple cables could be used. Thus, for example, in the case of a laser cutter employing a compound fluid laser jet the flexible support cable would include a high power optical fiber, a first line for the core jet fluid and a second line for the annular jet fluid. These lines could be combined into a single cable or they may be kept separate. Additionally, for example, if a laser cutter employing an oxygen jet is utilized, the cutter would need a high power optical fiber and an oxygen line. These lines could be combined into a single cable or they may be kept separate as multiple cables. The lines and optical fibers should be covered in flexible protective coverings or outer sheaths to protect them from riser fluids, the subsea environment, and the movement of the laser cutters, while at the same time remaining flexible enough to accommodate the orbital movement of the laser cutters. As the support cables near the feed-through assembly there to for flexibility decreases and more rigid means to protect them can be employed. For example, the optical fiber may be placed in a metal tube. The conduit that leaves the feet through assembly adds additional protection to the support cables, during assembly of the laser module and the riser, handling of the riser or module, deployment of the riser, and from the subsea environmental conditions. The conduits can carry, or include, power transmission lines, optical fibers, communication and data lines, fluid lines, to name a flew. In general, these conduits can carry any lines that may provide material, data or carry information needed or beneficial to the operation of the sub sea laser assembly.

It is preferable that the feed-through assemblies, the conduits, the support cables, the sub sea lasers, the sub sea power sources, the beam combiners, the laser cutters and other subsea components associated with the operation of the laser assemblies, should be constructed to meet the pressure requirements for the intended use. The laser related components, if they do not meet the pressure requirements for a particular use, or if redundant protection is desired, may be contained in or enclosed by a structure that does meet the requirements. For deep and ultra-deep water uses the laser related components should preferably be capable of operating under pressures of 2,000 psi, 4,500 psi, 5,000 psi or greater. The materials, fittings, assemblies, useful to meet these pressure requirements are known to those of ordinary skill in the offshore drilling arts, related sub-sea Remote Operated Vehicle (“ROV”) art, diving arts, submarine arts and in the high power laser arts.

In embodiments of the sub sea laser systems and assemblies, including semiconductor laser sources (e.g., diode laser arrays), for sub sea, and sub sea in situ generation, one or more components of the systems, and preferably the laser cutters that are used in the laser systems may be incorporated into laser shear rams, shear laser modules and laser riser modules. These devices and other configurations utilizing laser directed energy cutters such as laser cutters in association with a riser and BOP components are disclosed and taught in U.S. Pat. Nos. 8,783,361, 8,684,088, and 8,783,360, the entire disclosure of each of which is incorporated herein by reference.

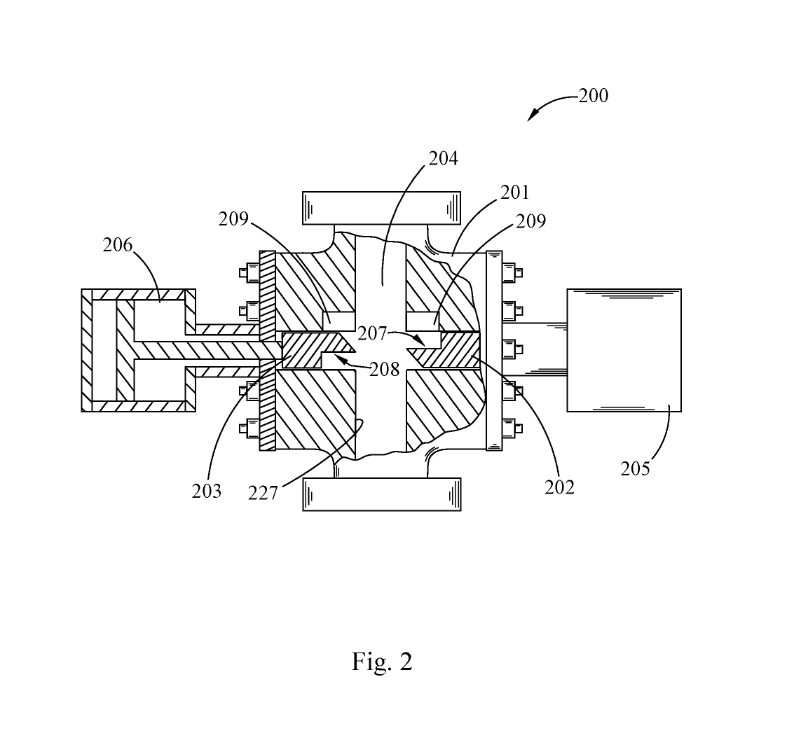

Turning to FIG. 2 there is shown an example of an embodiment of a laser shear ram assembly that could be used in a BOP stack. The laser shear ram assembly 200 has a body 201. The body 201 has a lower shear ram 202, (closer to the wellhead) and an upper shear ram 203 that upon activation are forced into inner cavity 204 by lower piston assembly 205 and upper piston assembly 206. Upon activation the mating surfaces 207, 208 of the shear rams 202, 203 engage each other and seal off the inner cavity 204, and thus, the well. The inner cavity 204 has an inner cavity wall 227. There is also provided a sub sea in situ laser generation and delivery assembly that may contain one or more of a laser, a beam combiner, a power source, a controller, and a cutter, e.g., in situ laser assembly 209. The laser assembly 209 is located in the body 201 of the laser shear ram assembly 200. The laser assembly 209 may be, for example, an annular assembly that surrounds, or partially surround, the inner cavity 204. This assembly 209 is located above shear rams 202, 203, i.e., the side further away from the wellhead.

During drilling and other activities tubulars, not shown in FIG. 2, are typically positioned within the inner cavity 204. An annulus is formed between the outer diameter of the tubular and the inner cavity wall 227. These tubulars have an outer diameter that can range in size from about 18″ down to a few inches, and in particular, typically range from about 16⅖ (16.04)″ inches to about 5″, or smaller. When tubulars are present in the cavity 204, upon activation of the laser shear ram assembly 200, the laser assembly 209 delivers high power laser energy to the tubular located in the cavity 204. The high power laser energy cuts the tubular completely, or at a minimum structurally weakens the tubular, to permit the shear rams 202, 203 to quickly seal off the cavity 204, moving any remaining tubular sections out of the way of the shear rams if the tubular was completely severed by the laser energy, or severing the tubular if only weakened by the laser and moving the severed tubular sections out of the way of the shear rams. Thus, the laser shear ram assembly 200 assures that the shear rams surface 207, 208 engage, seal, and thus, seal-off the BOP cavity 204 and the well. Although a single laser assembly is shown in the example of the embodiment of FIG. 2, multiple laser assemblies, assemblies of different shapes, and assemblies in different positions, may be employed. Further, configurations where the laser assembly is located below the shear rams, i.e., the side closer to the wellhead, as well as, configurations where laser assemblies are located above, below, within, or combinations thereof, the shear rams, or other sections or modules of the BOP stack may also be employed.

The ability of the laser energy to cut, remove or substantially weaken the tubular in the inner cavity enables the potential use of a single shear ram, where two shear rams may otherwise be required or needed; thus, reducing the number of moving parts, reducing the weight of the BOP, reducing the height of the BOP and reducing the deck footprint for the BOP, as well as other benefits, in the overall assembly.

Further, the ability to make precise and predetermined laser energy delivery patterns to tubulars and the ability to make precise and predetermined cuts in and through tubulars, provides the ability to have the shear ram cutting and mating surfaces configured in a way to match, complement, or otherwise work more efficiently with the laser energy delivery pattern. Thus, shear ram configurations matched or tailored to the laser energy delivery pattern are contemplated by the present inventions. Further, the ability to make precise and predetermined cuts in and through tubulars, provides the ability, even in an emergency situation, to sever the tubular without crushing it and to have a predetermined shape to the severed end of the tubular to assist in later attaching a fishing tool to recover the severed tubular from the borehole. Further, the ability to sever the tubular, without crushing it, provides a greater area, i,e., a bigger opening, in the lower section of the severed tubular through which drilling mud, or other fluid, can be pumped into the well, by the kill line associated with the BOP stack.

The body of laser shear ram assembly may be a single piece that is machined to accommodate the laser delivery assembly, or it may be made from multiple pieces that are fixed together in a manner that provides sufficient strength for its intended use, and in particular to withstand pressures of 5,000 psi, 10,000 psi, 15,000 psi, 20,000 psi, and greater. The area of the body that contains the laser assembly may be machined out, or otherwise fabricated to accommodate the laser assembly, while maintaining the strength requirements for the body's intended use. The body of the laser shear ram assembly may also be two or more separate components or modules, e.g., one component or module for the laser assembly and another for the shear rams. These modules could be attached to each other by, for example, bolted flanges, or other suitable attachment means known to those of skill in the offshore drilling art. The body, or a module making up the body, may have a passage, passages, channels, or other such structures, to convey cables and lines for transmission of the laser beam from the laser source into the body, transmission of power to the laser source, and transmission of data and information to and from the laser assembly, as well as, other cables that relate to the operation or monitoring of the laser assembly and its cutting or other operation.

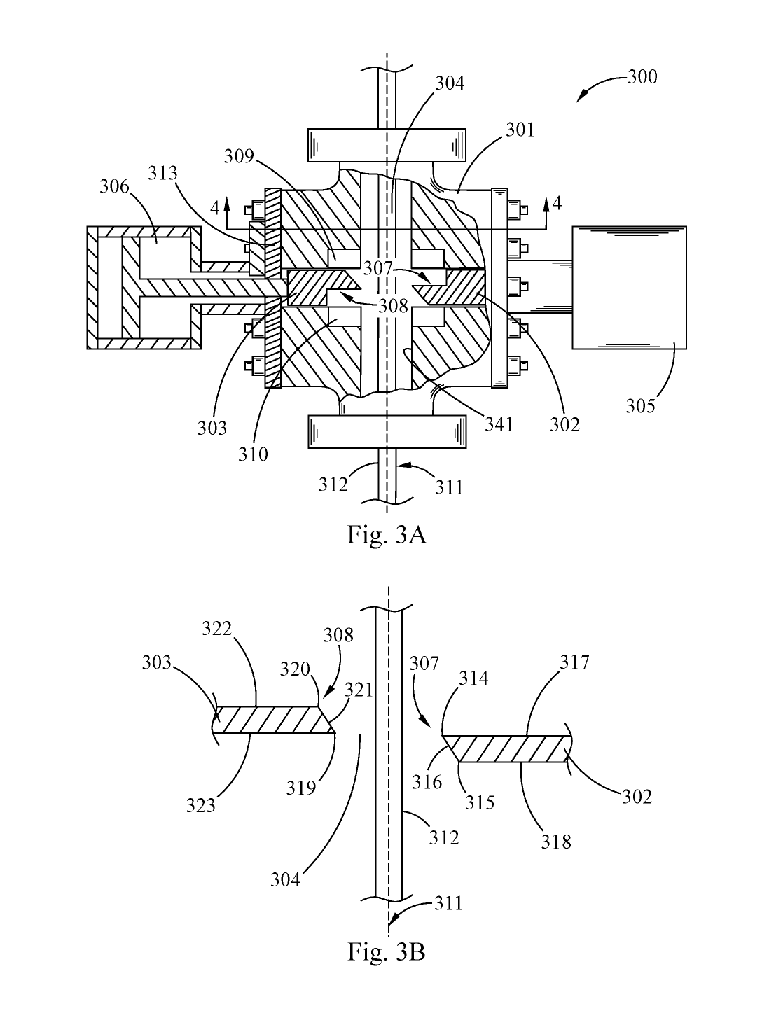

In FIG. 3A there is shown an example of an embodiment of a laser shear ram assembly that could be used in a laser assisted BOP. Thus, there is shown a laser shear ram assembly 300 having a body 301. The body has a cavity 304, which cavity has a center axis 311 (dashed line) and a wall 341. The BOP cavity also has a vertical axis and in this embodiment the vertical axis and the center axis are the same, which is generally the case for BOPS. (The naming of these axes are based upon the configuration of the BOP and are relative to the BOP structures themselves, not the position of the BOP with respect to the surface of the earth. Thus, the vertical axis of the BOP will not change if the BOP for example were laid on its side.) Typically, the center axis of cavity 311 is on the same axis as the center axis of the wellhead cavity or opening through which tubulars are inserted into the borehole.

The body 301 contains and supports lower shear ram 302 and upper shear ram 303, which rams have piston assemblies 305 and 306 associated therewith. In operation, the piston assemblies 305, 306 drive the rams 302, 303 toward the center axis 311, engaging, cutting and moving through tubular 312, and sealing the cavity 304, and thus, the well. The body 301 also has a feed-through assembly 313 for managing pressure and permitting power cables and other cables, tubes, wires and conveyance means, which may be needed for the operation of the in situ laser assembly, to be inserted into the body 301. The body houses an upper laser delivery assembly 309 and a lower laser delivery assembly 310.

Turning to FIG. 3B there is shown a more detailed illustration of shear ram mating surfaces 308, 307 of the embodiment shown in FIG. 3A. Thus, mating surfaces 308 of upper shear ram 303 have an upper surface 322, a lower surface 323, a face 321, a leading edge 319, which edge is between the lower surface 323 and the face 321, and a trailing edge 320, which edge is between the upper surface 322 and the face 321. Mating surfaces 307 of lower shear ram 302 has an upper surface 317, a lower surface 318, a face 316, a leading edge 314, which edge is between the upper surface 317 and the face 316, and a trailing edge 315, which edge is between the face 316 and the lower surface 318.

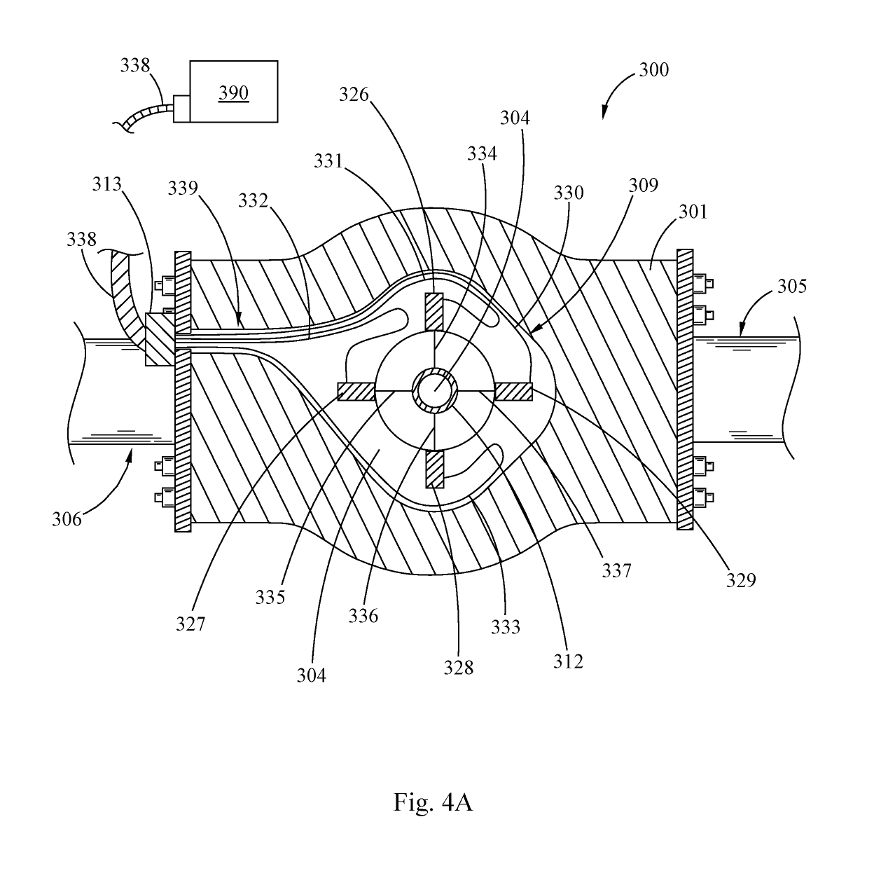

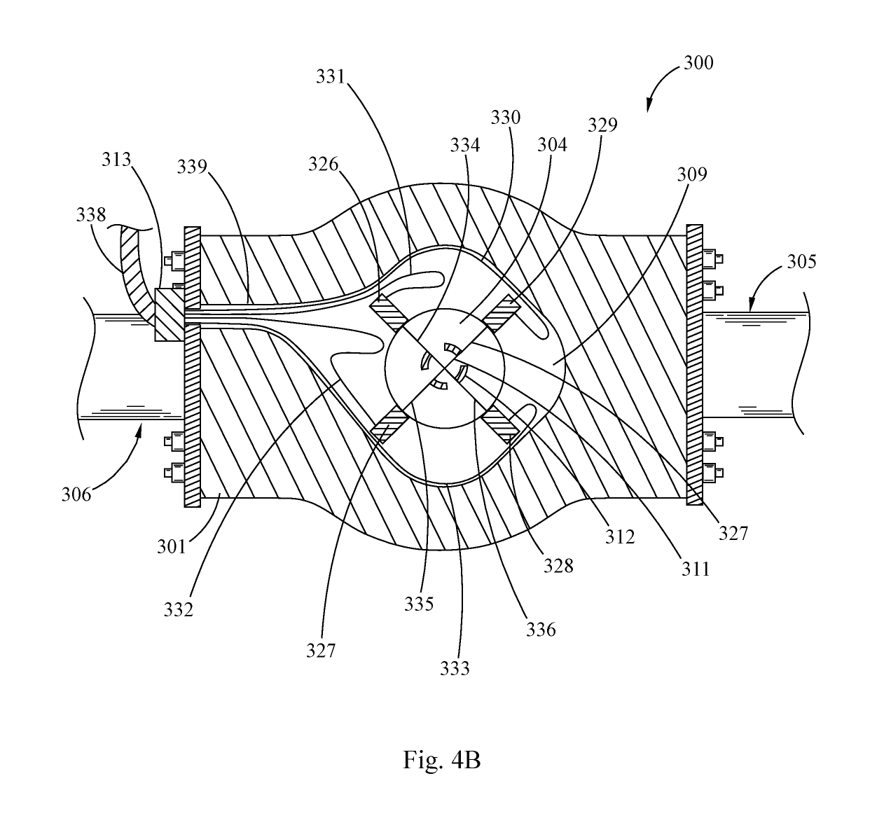

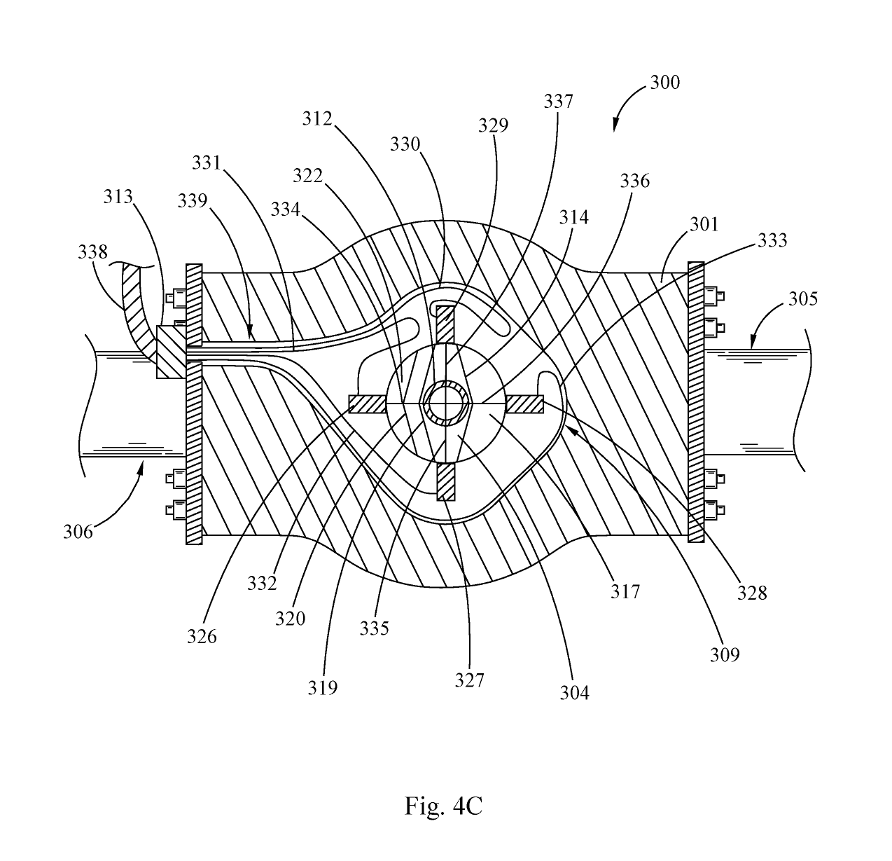

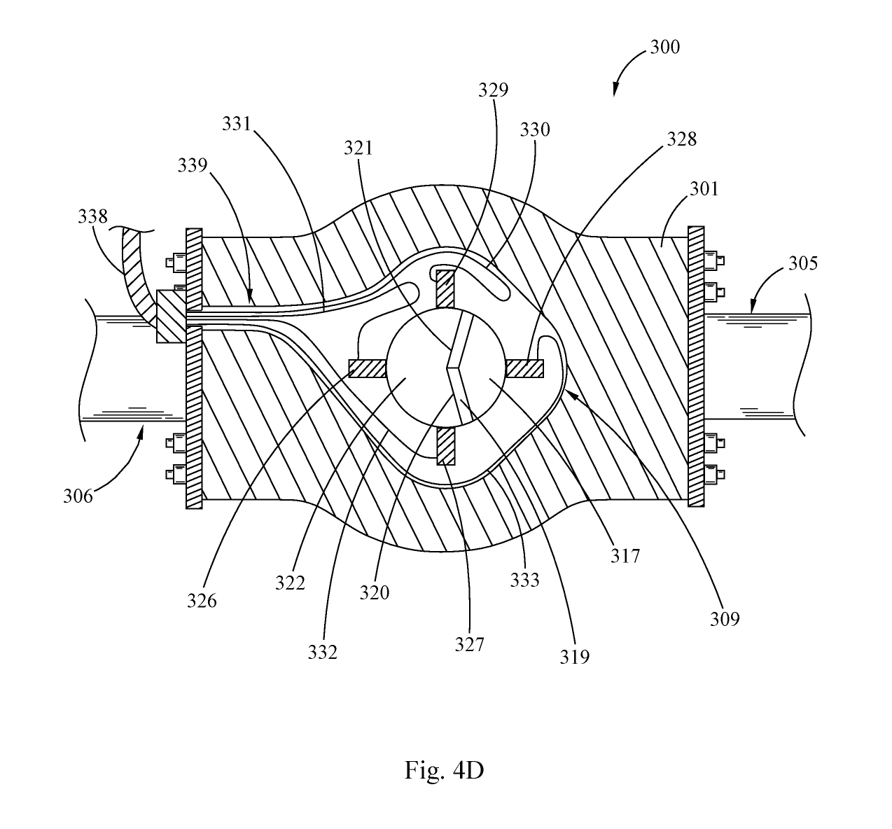

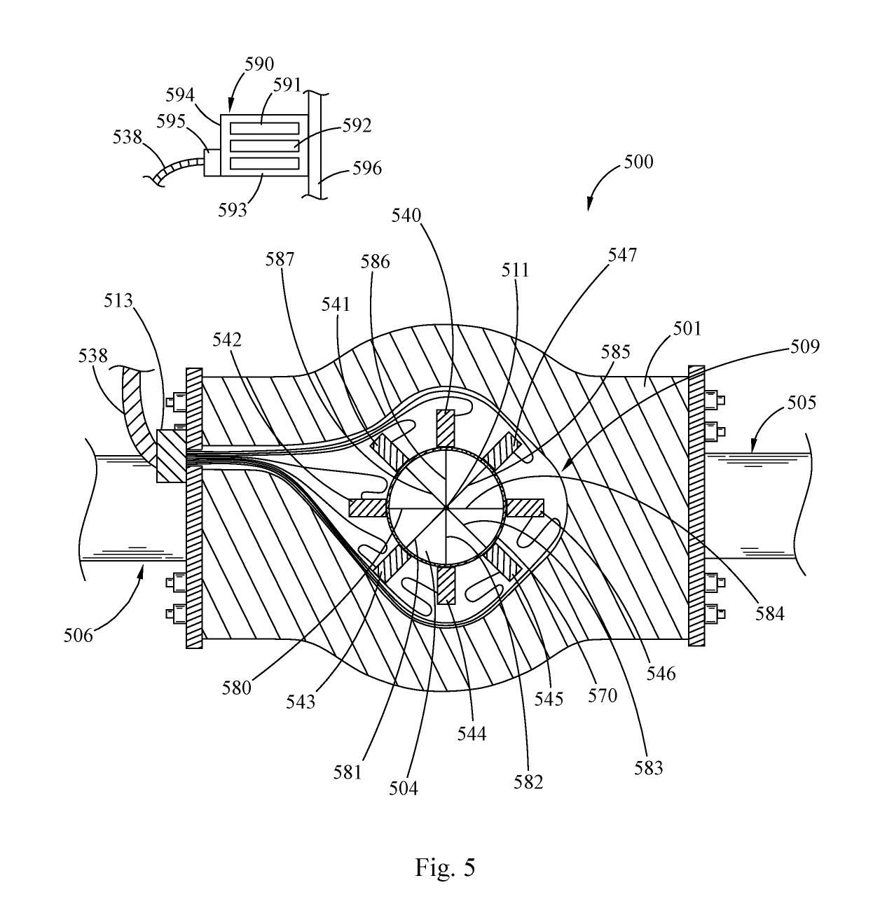

FIGS. 4A to 4D, are cross-sectional views of the embodiment shown in FIGS. 3A and 3B taken along line 4-4 of FIG. 3A and show the sequence of operation of the laser shear ram assembly 300, in cutting the tubular 312 and sealing the cavity 304. In FIGS. 4A to 4D there is also shown further detail of the upper laser delivery assembly 309 of laser ram assembly 300. In this embodiment, lower laser assembly 310 could have similar components and configurations as upper laser delivery assembly 309. However, lower laser assembly 310 could have different configurations and more or fewer laser assemblies.

The laser delivery assembly 309 has four sub sea in situ integrated laser assemblies 326, 327, 328, and 329, each having a laser source integral with and optically connected to a laser cutter. Flexible support cables are associated with each of the integrated laser assemblies. Thus, flexible support cable 331 is associated with integrated laser assemblies 326, flexible support cable 332 is associated with integrated laser assemblies 327, flexible support cable 333 is associated with integrated laser assemblies 328, and flexible support cable 330 is associated with integrated laser assemblies 329. The flexible support cables are located in channel 339 and enter feed-through assembly 313. In the general area of the feed-through assembly 313, the support cables transition from flexible to semi-flexible, and may further be included in conduit 338 for conveyance to a power supply 390. The power supply may be sub surface, above the surface and both (in the case of multiple power supplies). The power supply 390 can be for example a battery, a generator, a laser for optical pumping or opto-electric conversion, as well as, other sources of materials for the cutting operation. The flexible support cables 330, 331, 332, and 333 have extra, or additional length, which accommodates the orbiting of the integrated laser assemblies 326, 327, 328 and 329 around the axis 311, and around the tubular 312.

FIGS. 4A to 4D show the sequence of activation of the laser shear ram assembly 300 to sever a tubular 312 and seal off the cavity 304. In this example, the first view (e.g., a snap shot, since the sequence preferably is continuous rather than staggered or stepped) of the sequence is shown in FIG. 4A. As activated the four integrated laser assemblies 326, 327, 328 and 329 shoot laser beams 334, 335, 336 and 337 respectively. The beams are directed toward the center axis 311. As such, the beams are shot from within the BOP, from outside of the cavity wall 327, and travel toward the center axis of the BOP. The laser beams strike tubular 312 and begin cutting, i.e., removing material from, the tubular 312. If the cavity 304 is viewed as the face of a clock, the integrated laser assemblies 326, 327, 328 and 329 could be viewed as being initially positioned at 12 o'clock, 9 o'clock, 6 o'clock and 3 o'clock, respectively. Upon activation, the integrated laser assemblies and their respective laser beams, begin to orbit around the center axis 311, and the tubular 312. (In this configuration the integrated laser assemblies would also rotate about their own axis as they orbit, and thus, if they moved through one complete orbit they would also have moved through one complete rotation.) In the present example the cutters and beams orbit in a counter clockwise direction, as viewed in the figures; however, a clockwise rotation may also be used. As the laser beams are shot and the orbiting occurs, the shear rams 303, 302 are driven towards each other and toward the tubular 312.

Thus, as seen in the next view of the sequence, FIG. 4B, the integrated laser assemblies, 326, 327, 328 and 329 have rotated 45 degrees, with laser beams that travel along beam paths 334,335, 336, and 337 having cut through four ⅛ sections (i.e., a total of half) of the circumference of the tubular 312. FIG. 4C then shows the cutter having moved through a quarter turn. Thus, in FIG. 4C, the integrated laser assemblies, 326, 327, 328 and 329 have rotated a quarter turn, with the laser beams 334, 335, 336 and 337 having cut through the tubular 312. Thus, integrated laser assemblies 326 could be seen as having moved from the 12 o'clock position to 9 o'clock position, with the other assemblies having similarly changed their respective clock face positions. There is further shown upper surface 322, trailing edge 320, face 321, and leading edge 319, of the upper ram and upper surface 317 and leading edge 314 of the lower ram as they approach and engage the tubular 312 and the area where the laser beams have cut the tubular.

FIG. 4D then shows the last view of the sequence with the integrated laser assemblies having been deactivated and no longer shooting their laser beams and the shear rams in sealing engagement. The cavity 304 is completely filled and blocked by the shear rams 303, 302. As seen in FIG. 4C only upper surface 322, trailing edge 320, and leading edge 319 of the upper ram 303 and a portion of upper surface 317 of the lower ram 302, the other portions of upper surface 317 being in engagement with lower surface 323 of ram 302.

During the cutting operation, and in particular for circular cuts that are intended to sever the tubular, it is preferable that the tubular not move in a vertical direction. Thus, at or before the laser cutters are fired, the pipe rams, the annular preventer, or a separate holding device should be activated to prevent vertical movement of the pipe during the laser cutting operation.

The rate of the orbital movement of the laser cutters is dependent upon the number of cutters used, the power of the laser beam when it strikes the surface of the tubular to be cut, the thickness of the tubular to be cut, and the rate at which the laser cuts the tubular. The rate of the orbital motion should be slow enough to ensure that the intended cuts can be completed. The orbital movement of the laser cutters can be accomplished by mechanical, hydraulic and electro-mechanical systems known to the art.

The use of the term “completed” cut, and similar such terms, includes severing the object to be cut into two sections, e.g., a cut that is all the way through the wall and around the entire circumference of the tubular, as well as, cuts in which enough material is removed from the tubular to sufficiently weaken the object to ensure that it separates as intended. Depending upon the particular configuration of the laser cutters, the riser and the BOP and their intended use, a completed cut could be, for example: severing a tubular into two separate sections; the removal of a ring of material around the outer portion of the tubular, from about 10% to about 90% of the wall thickness; a number of perforations created in the wall, but not extending through the wall of the tubular; a number of perforations going completely through the wall of the tubular; a number of slits created in the wall, but not extending through the wall of the tubular; a number of slits going completely through the wall of the tubular; the material removed by the shot patterns or laser cutter placements disclosed in this and the incorporated by reference co-filed specifications; or, other patterns of material removal and combinations of the foregoing. It is preferred that the complete cut is made in less than one minute, and more preferable that the complete cut be made in 30 seconds or less.

The rate of the orbital motion can be fixed at the rate needed to complete a cut for the most extreme tubular or combination of tubulars, or the rate of rotation could be variable, or predetermined, to match the particular tubular, or types of tubulars, that will be present in the BOP during a particular drilling operation.

The greater the number of laser cutters in a rotating laser delivery assembly, the slower the rate of orbital motion can be to complete a cut in the same amount of time. Further, increasing the number of laser cutters decreases the time to complete a cut of a tubular, without having to increase the orbital rate. Increasing the power of the laser beams will enable quicker cutting of tubulars, and thus allow faster rates of orbiting, fewer laser cutters, shorter time to complete a cut, or combinations thereof.

Variable ram preventers could be used in conjunction with oxygen (or air) and laser cutters. Thus, a single variable ram could be used to grasp and seal against a tubular in the BOP cavity. The variable ram would form a small cavity within the rams, when engaged against the tubular, which cavity would surround the tubular. This cavity could then have its pressure reduced to at or near atmospheric, by venting the cavity. Oxygen, or air, (or other gases or transmissive liquids) could be added to the cavity before the laser cutters, which would be contained within the rams, are fired. In this manner the variable rams would have laser cutters therein, form an isolation cavity when engaged with a tubular, and provide a means to quickly cut the tubular with minimal interference from fluids. Two variable rams, one above the other may also be used, if a larger isolation cavity is desirable, or if additional space is needed for the laser cutters. Moreover, although the cavity could be vented to at or about atmospheric pressure, an increased pressure may be maintained, to for example, reduce or slow the influx of any drilling fluid from within the tubular as it is being cut.

In FIG. 5 there is shown an example of an embodiment of a laser ram assembly that could be used in a laser assisted BOP. Thus, there is shown a laser shear ram assembly 500 having a body 501. The body has a cavity 504, which cavity has a center axis 511. The body 501 also has a feed-through assembly 513 for managing pressure and permitting optical fiber cables and other cables, tubes, wires and conveyance means, which may be needed for the operation of the laser cutter, to be inserted into the body 501. Ram piston assemblies 505, 506, which are partially shown in this Figure, are associated with the body 501. The body houses a laser delivery assembly 509. The laser delivery assembly 509 has eight laser cutters 540, 541, 542, 543, 544, 545, 546 and 547. Flexible support cables are associated with each of the laser cutters. The flexible support cables have sufficient length to accommodate the orbiting of the laser cutters around the center axis 511. In this embodiment the cutters need only go through ⅛ of a complete orbit to obtain a cut around the entire circumference of a tubular. The flexible support cables are located in a channel and enter feed-through assembly 513. Feed-through assembly is pressure rated to the same level as the BOP, and thus should be capable of withstanding pressures of 5,000 psi, 10,000 psi, 15,000 psi, 20,000 psi and greater. In the general area of the feed-through assembly 513 the support cables transition from flexible to semi-flexible, and may further be included in conduit 538 for conveyance to a high power laser, or other sources. The conduit 538 connects to a sub sea laser source 590 that is attached to and located inside of the BOP frame 596. The sub sea laser source 590 has a battery source to provide electric power to an array of laser diodes, having a wavelength in the range of about 400 nm to 880 nm, and a beam combiner that provides operation laser beams to optical fibers that are contained within conduit 538 and that are optically associated with the laser cutters to provide the operation laser beam to the laser cutters. The laser source 590 has a protective housing 594 and feed-through assembly 595.

There is also provided a shield 570. This shield 570 protects the laser cutters and the laser delivery assembly from drilling fluids and the movement of tubulars through the BOP cavity. Is it preferably positioned such that it does not extend into, or otherwise interfere with, the BOP cavity or the movement of tubulars through that cavity. It is preferably pressure rated at the same level as the other BOP components. Upon activation, it may be mechanically or hydraulically moved away from the laser beam's path or the laser beam may propagate through it, cutting and removing any shield material that initially obstructs the laser beam. Upon activation the lasers cutters propagate laser beams (which also may be referred to as shooting the laser or firing the laser to create a laser beam) from outside of the BOP cavity into that cavity and toward any tubular that may be in that cavity. Thus, there are laser beam paths 580, 581, 582, 583, 584, 585, 586, and 587, which paths rotate around center axis 511 during operation.

In general, operation of a laser assisted BOP stack where at least one laser beam is directed toward the center of the BOP and at least one laser cutter is configured to orbit (partially or completely) around the center of the BOP to obtain circumferential cuts, i.e., cuts around the circumference of a tubular (including slot like cuts that extend partially around the circumference, cuts that extend completely around the circumference, cuts that go partially through the tubular wall thickness, cut that go completely through the tubular wall thickness, or combinations of the foregoing) may occur as follows. Upon activation, the laser cutter fires a laser beam toward the tubular to be cut. At a time interval after the laser beam has been first fired the cutter begins to move, orbiting around the tubular, and thus the laser beam is moved around the circumference of the tubular, cutting material away from the tubular. The laser beam will stop firing at the point when the cut in the tubular is completed. At some point before, during, or after the firing of the laser beam, ram shears are activated, severing, displacing, or both any tubular material that may still be in their path, and sealing the BOP cavity and the well.

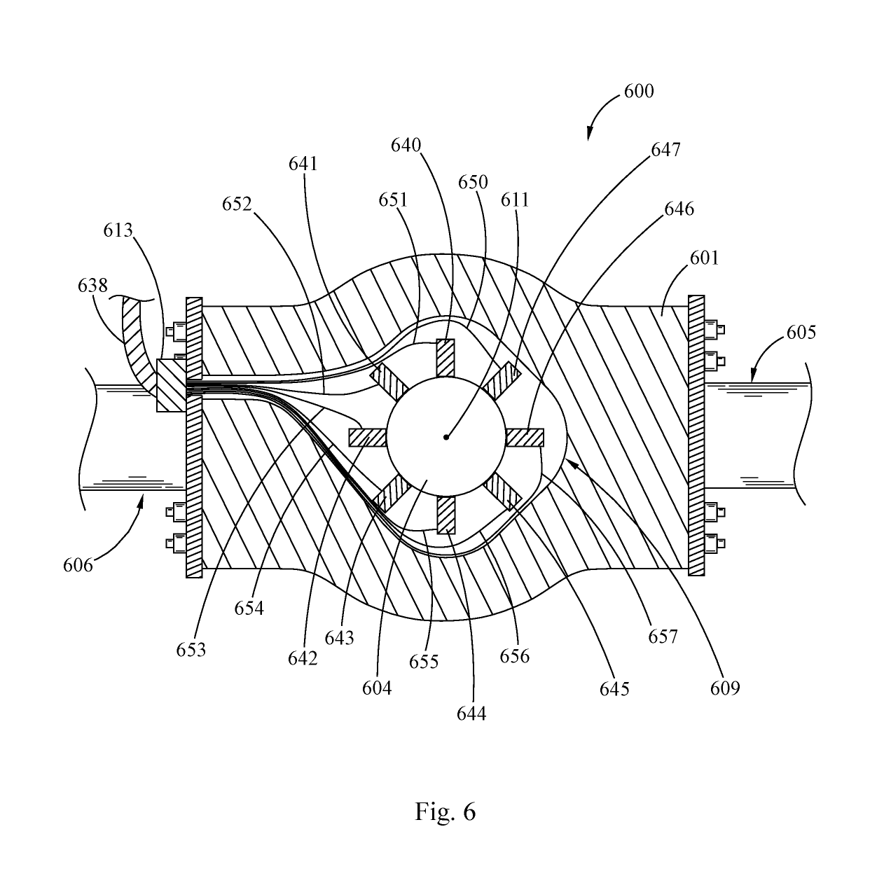

In FIG. 6 there is shown an example of an embodiment of a laser ram assembly, having fixed laser cutters, for use in a laser assisted BOP. Thus, there is shown a laser shear ram assembly 600 having a body 601. The body has a cavity 604, which cavity has a center axis 611. The body 601 also has a feed-through assembly 613 for managing pressure and permitting optical fiber cables and other cables, tubes, wires and conveyance means, which may be needed for the operation of the laser cutter, to be inserted into the body 601. Ram piston assemblies 605, 606, which are partially shown in this Figure, are associated with the body 601. The body houses a laser delivery assembly 609. The laser delivery assembly 609 has eight sub sea in situ laser assemblies 640, 641, 642, 643, 644, 645, 646 and 647. In this embodiment the laser assemblies and thus the cutters do not orbit or move. The cutters are configures such that their beam paths (not shown) are radially distributed around and through the center axis 611. Support cables 650, 651, 652, 653, 654, 655, 656 and 657 are associated with each of the laser assemblies 640, 641, 642, 643, 644, 645, 646 and 647 respectively and provide power to the lasers. The support cables in this embodiment do not need to accommodate the orbiting of the laser assemblies around the center axis 611, because the laser assemblies and thus the laser cutters are fixed and do not orbit. Further, because the laser assemblies are fixed the support cables 650, 651, 652, 653, 654, 655, 656 and 657 may be semi-flexible or ridged and the entire assembly 609 may be contained within an epoxy of other protective material. The support cables are located in a channel and enter feed-through assembly 613. Feed-through assembly is pressure rated to the same level as the BOP, and thus should be capable of withstanding pressures of 5,000 psi, 10,000 psi, 15,000 psi, 20,000 psi and greater. In the general area of the feed-through assembly 613 the support cables transition from flexible to semi-flexible, and may further be included in conduit 638. A shield, such as the shield 570 in FIG. 5, may also be used with this and other embodiments, but is not shown in this Figure.

Although eight evenly spaced laser cutters are shown in the example of a fixed laser cutter embodiment in FIG. 6, other configurations are contemplated. Fewer or more laser cutters may be used. The cutters may be positioned such that their respective laser beam paths are parallel, or at least non-intersecting within the BOP, instead of radially intersecting each other, as would be the case for the embodiment shown in FIG. 6.

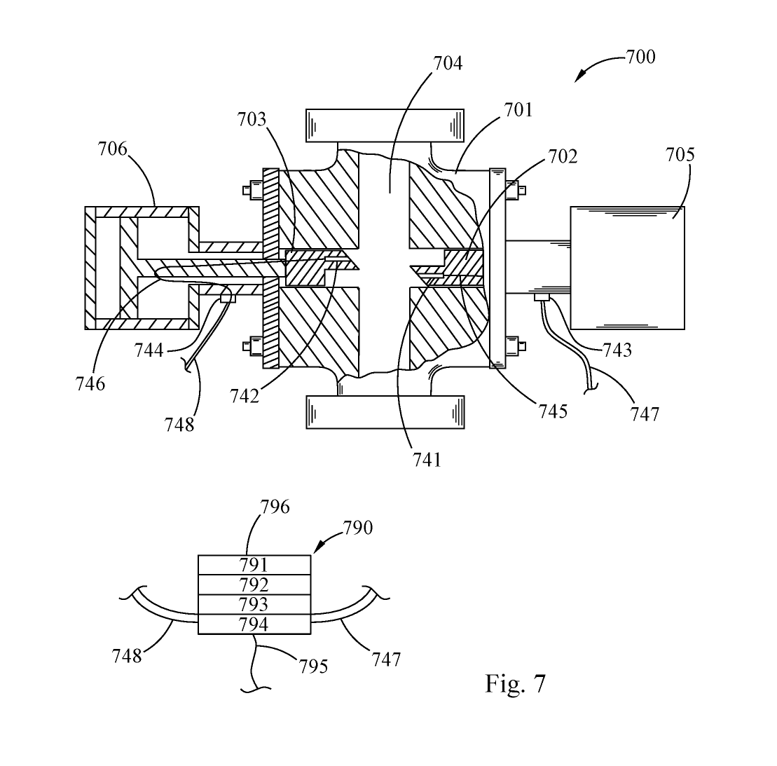

Turning to FIG. 7 there is shown an example of an embodiment of a laser shear ram assembly that could be used in a laser assisted BOP. The laser shear ram assembly 700 has a body 701. The body 701 has a lower shear ram 702, (closer to the wellhead) and an upper shear ram 703 that upon activation are forced into inner cavity 704 by lower piston assembly 705 and upper piston assembly 706. There is also provided laser delivery assemblies 741, 742. Laser delivery assemblies 741, 742 are located in rams 702, 703 respectively. The laser delivery assemblies 741, 742 have flexible support cables 745, 746 respectively, which pass through feed-through assemblies 743, 744 respectively, into conduits 747, 748 respective, which conduits are optically associated with at least one high power laser source 790. The high power laser source 790 is sub sea, and can be located on the BOP frame, within the BOP frame, or on the sea floor. The sub sea laser source 790 has a protective housing 796 that contains a controller 791, a power source (e.g. battery) 792, an array of diode lasers 793 and beam combiners 794. There is also a control, data and information line 795. The feed-through assemblies as well as all places where the flexible support cable passes through should be pressure rated to meet the requirements of the BOP and specifically the pressure requirements associated with the structures through which the cable is passed. Sufficient lengths of the flexible support cables 745, 746 are provided to accommodate the movement of the shear rams 702, 703 and the piston assemblies 705,706.

During drilling and other activities tubulars, not shown in FIG. 7, are typically positioned within the inner cavity 704. When tubulars are present in the cavity 704, upon activation of the laser shear ram assembly 700, the laser delivery assemblies 741, 742 deliver high power laser energy to the tubular located in the cavity 704. The high power laser energy cuts the tubular completely, or at a minimum weakens the tubular, to permit the shear rams 702, 703 to quickly seal-off the cavity 704, moving the tubular sections out of the way of the shear rams if completely cut by the laser energy, or cutting the tubular if only weakened by the laser and moving the tubular sections out of the way of the shear rams, and thus, assuring that the shear rams surface 707, 708 engage, seal, and thus, seal-off the BOP cavity 704 and the well.

By having the laser delivery assemblies in the rams, such as laser delivery assemblies 741, 742 of the embodiment seen in FIG. 7, the distance of the laser beam path through any drilling fluids can be greatly reduced if not eliminated. Thus, the firing of the laser beam may be delayed until the rams are very close to, or touching, the tubular to be cut.

Shields for the laser cutters or laser delivery assemblies may also be used with laser ram configurations, such as the embodiment shown in FIG. 7, where the cutters or assemblies are located in the rams. Thus, such shields may be associated with the ram faces and removed upon activation or cut through by the laser beam.

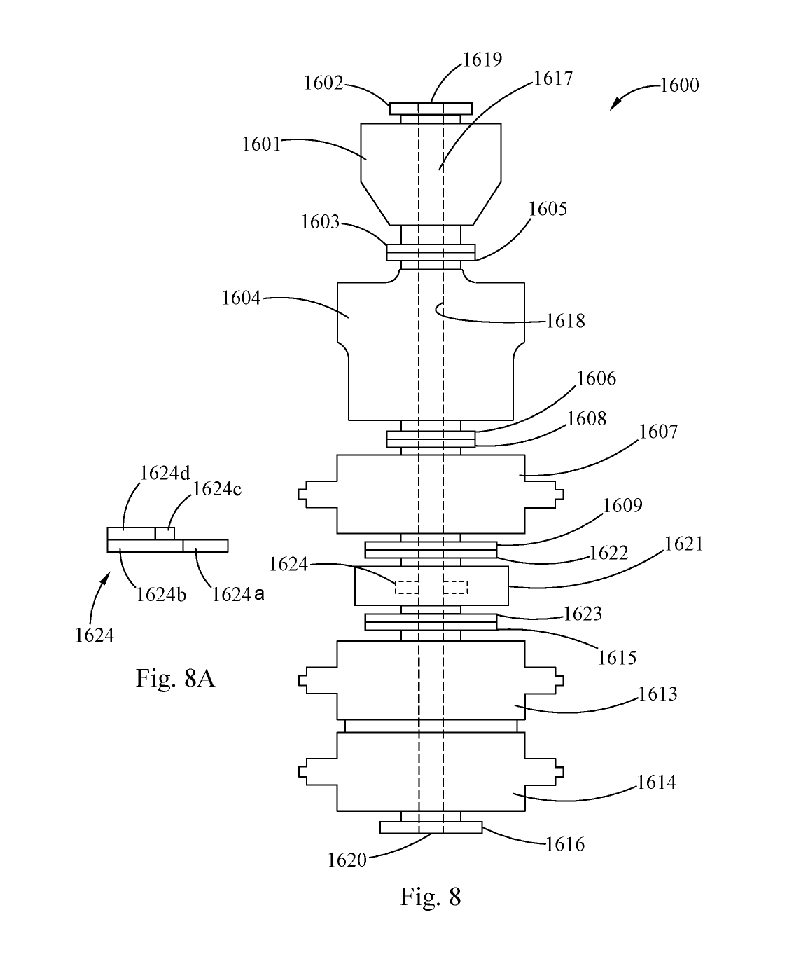

Turning to FIG. 8 there is shown an example of an embodiment of a laser assisted BOP stack. Thus, there is shown a laser assisted BOP stack 1600 having, from top 1619 to bottom 1620, a flex joint 1601 with connecters 1602, 1603, an annular preventer 1604 with connecters 1605, 1606, a shear ram 1607 with connecters 1608, 1609, a shear laser assembly 1621 with connecters 1622, 1623 (having a sub sea in situ laser assembly 1624 shown in phantom lines), and pipe ram 1613 and pipe ram 1614 with connecters 1615, 1616. The connecters, e.g., 1602 can be any type of connecter known or used by those of skill in the offshore drilling arts, such as for example a flange with bolts, that meet the pressure requirements for the BOP. Each of the components, e.g., shear ram 1607, in the BOP stack 1600 have an internal cavity, or bore, having a wall, which when assembled into the BOP stack forms an inner cavity 1617 having a wall 1618 (shown as in phantom lines in the drawing). Turning to FIG. 8A there is shown a detailed schematic of the laser assembly 1624, having a laser cutter 1624a, a laser beam source 1624b (e.g., semiconductor lasers), a battery 1624d and a controller 1624e.

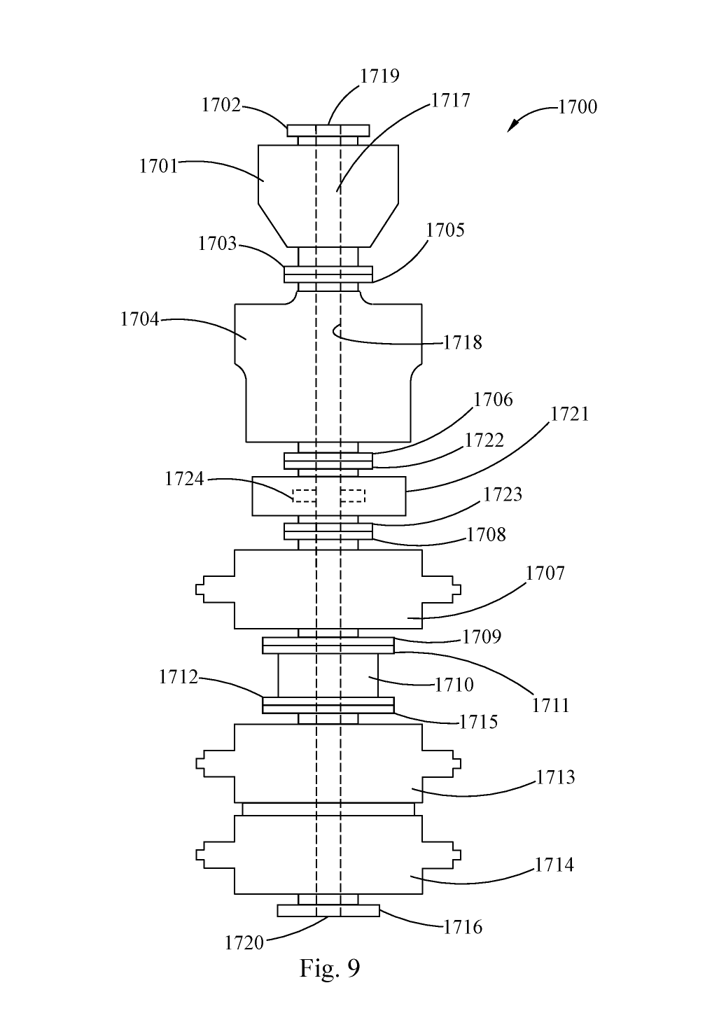

In FIG. 9 there is shown an example of a laser assisted BOP stack. Thus, there is shown a laser assisted BOP stack 1700 having, from top 1719 to bottom 1720, a flex joint 1701 with connecters 1702, 1703, an annular preventer 1704 with connecters 1705, 1706, a shear laser assembly 1721 with connecters 1722, 1723 (having a sub sea laser delivery assembly 1724 shown in phantom lines), a shear ram 1707 with connecters 1708, 1709, a spacer 1710 with connecters 1711, 1712, and pipe rams 1713, 1714 with connecters 1715, 1716. The connecters, e.g., 1702 can be any type of connecter known or used by those of skill in the offshore drilling arts, such as for example a flange with bolts, that meet the pressure requirements for the BOP. Each of the components, e.g., shear ram 1707, in the BOP stack 1700 have an internal cavity, or bore, having a wall, which when assembled into the BOP stack forms an inner cavity 1717 having a wall 1718 (shown as in phantom lines in the drawing).

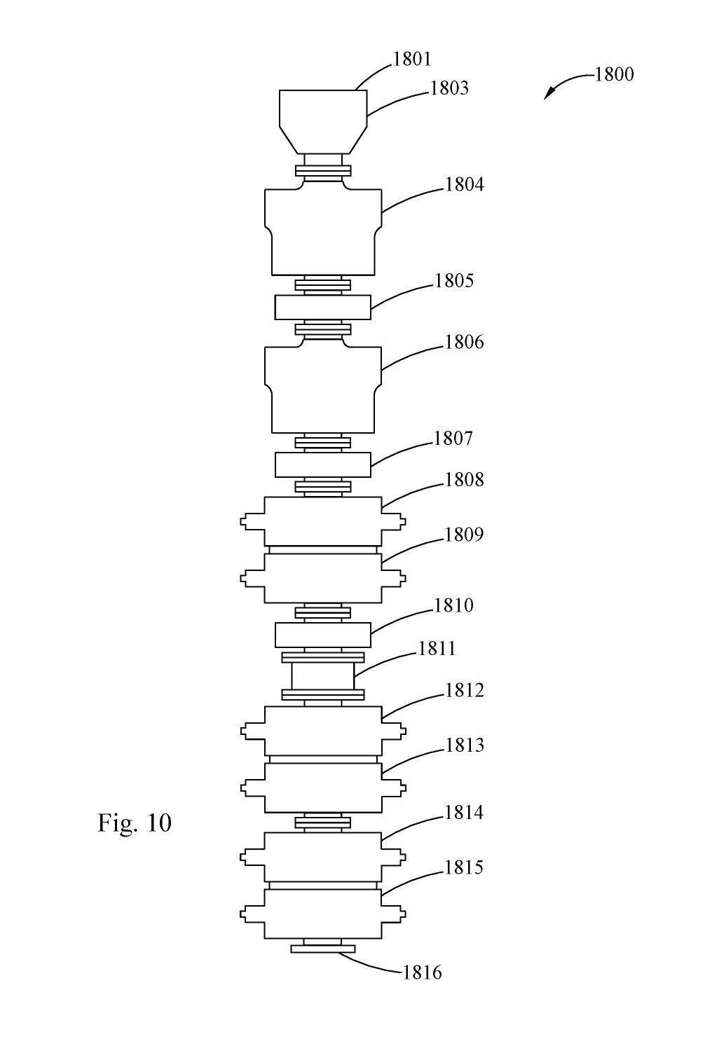

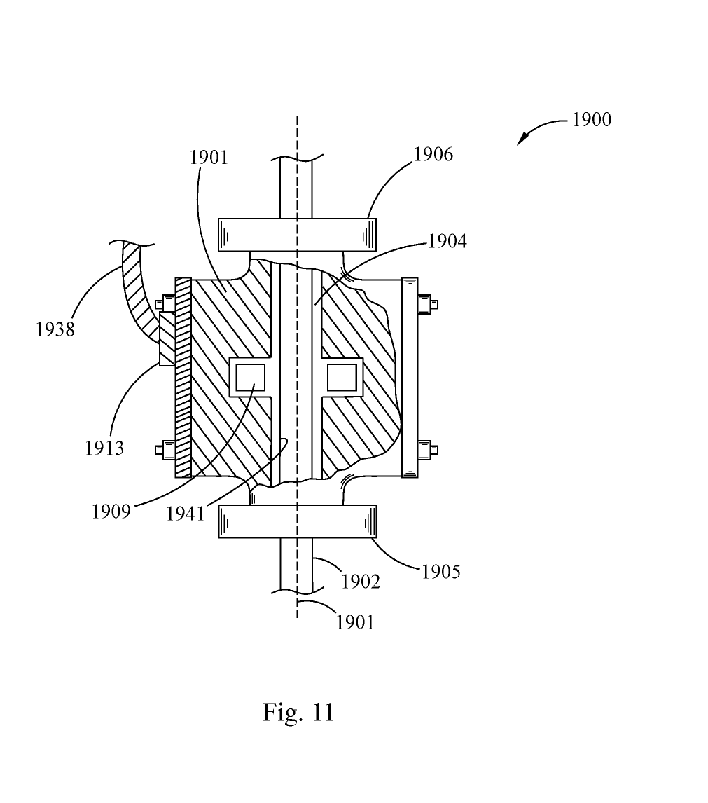

In FIG. 10 there is shown an example of a laser assisted BOP stack for ultra deep-water operations of 10,000 feet and greater, although this stack would also operate and be useful at shallower depths. Listing the components from the top of the stack 1801 to the bottom of the stack 1815, the laser assisted BOP stack 1800, has a flex joint 1803, an annular preventer 1804, a sub sea in situ shear laser module 1805, an annular preventer 1806, a shear laser module 1807, a shear ram 1808, a shear ram 1809, a sub sea shear laser module 1810, a spacer 1811, pipe rams 1812, 1813 and pipe rams 1814, 1815. These components each have bores and when assembled in the stack the bores form a cavity (not shown in this figure) extending from the top 1801 to the bottom 1815 of the stack. The shear laser modules have laser delivery assemblies (not shown in this figure) The components are connected together with connecters of any type suitable for, and that would meet the requirements of, offshore drilling and for this example in particular that would meet the requirements of ultra-deep water offshore drilling.

The laser assisted BOP stacks of may be used to control and manage both pressures and flows in a well; and may be used to manage and control emergency situations, such as a potential blowout. In addition to the shear laser module, the laser assisted BOP stacks may have an annular preventer. The annular preventers may have an expandable packer that seals against a tubular that is in the BOP cavity preventing material from flowing through the annulus formed between the outside diameter of the tubular and the inner cavity wall of the laser assisted BOP. In addition to the shear laser module, the laser assisted BOP stacks may have ram preventers. The ram preventers may be, for example: pipe rams, which may have two half-circle like clamping devices that are driven against the outside diameter of a tubular that is in the BOP cavity; blind ram that can seal the cavity when no tubulars are present, or they may be a shear rams that can cut tubulars and seal off the BOP cavity; or they may be a shear laser ram assemblies In general, laser shear rams assemblies use a laser beam to cut or weaken a tubular, including drilling collars, pipe joints, and bottom hole assemblies that might be present in the BOP cavity.

Turning to FIG. 11 there is shown an example of an embodiment of a sub sea in situ shear laser module (“SLM”) that could be used in a laser assisted BOP stack. The SLM 1900 has a body 1901. The body 1901 has a first connecter 1905 and a second connecter 1906. The inner cavity 1904 has an inner cavity wall 1941. There is also provided a laser delivery assembly 1909. The laser delivery assembly 1909 is located in body 1901. The laser delivery assembly 1909 may be, for example, an annular assembly that surrounds, or partially surround, the inner cavity 1904. This assembly 1909 is optically associated with at least one high power laser source.

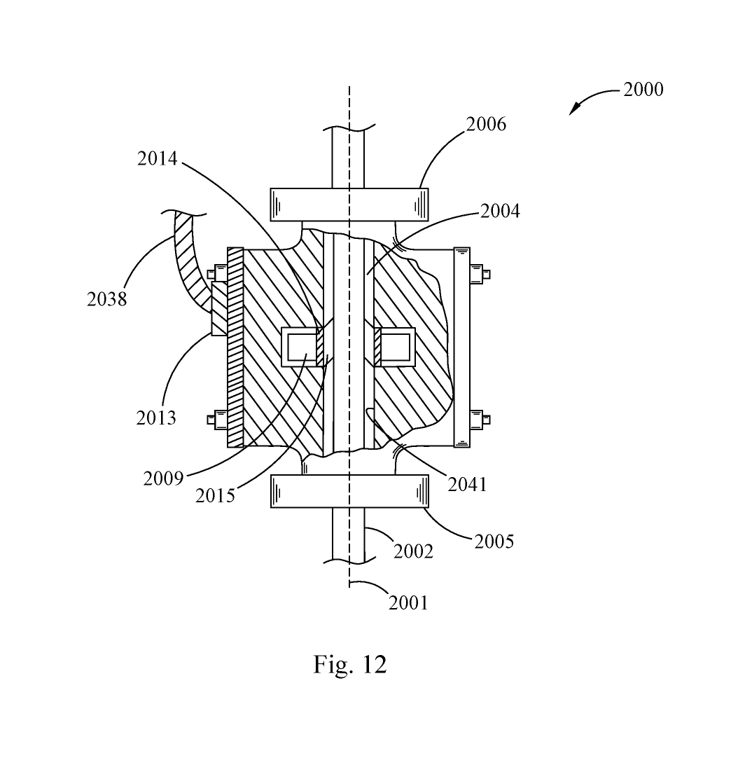

Turning to FIG. 12 there is shown an example of an embodiment of a sub sea in situ shear laser module (“SLM”) that could be used in a laser assisted BOP stack. The SLM 2000 has a body 2001. The body 2001 has a first connecter 2005 and a second connecter 2006. The inner cavity 2004 has an inner cavity wall 2041. There is also provided a laser delivery assembly 2009. The laser delivery assembly 2009 is located in body 2001. The laser delivery assembly 2009 may be, for example, an annular assembly that surrounds, or partially surround, the inner cavity 2004. This assembly 2009 is optically associated with at least one high power laser source.

The embodiment of FIG. 12 further contains a shield 2014 for the laser delivery assembly 2009. The shield 2014 is positioned within the body 2001, such that its inner surface or wall 2015 is flush with the cavity wall 2041. In this manner the shield does not form any ledge or obstruction in the cavity 2004. The shield can protect the laser delivery assembly 2009 from drilling fluids. The shield may also manage pressure, or contribute to pressure management, for the laser delivery assembly 2009. The shield may further protect the laser delivery assembly 2009 from tubulars, such as tubular 2002, as they are moved through, in or out of the cavity 2004. The shield may be made of a material, such as steel or other type of metal or other material, that is both strong enough to protect the laser delivery assembly 2009 and yet be quickly cut by the laser beam when it is fired toward the tubular 2002. The shield could also be removable from the beam path of the laser beam. In this configuration upon activation of the laser delivery assembly 2009 the shield would be moved away from the beam path. In the removable shield configuration the shield would not have to be easily cut by the laser beam.

During drilling and other activities, tubulars are typically positioned within the BOP inner cavity. An annulus is formed between the outer diameter of the tubular and the inner cavity wall. These tubulars have an outer diameter that can range in size from about 18″ down to a few inches, and in particular, typically range from about 16⅖ (16.04)″ inches to about 5″, or smaller. When tubulars are present in the cavity, upon activation of the SLM, the laser delivery assembly delivers high power laser energy to the tubular located in the cavity. The high power laser energy cuts the tubular completely permitting the tubular to be moved or dropped away from the rams or annular preventers in the stack, permitting BOP to quickly seal off the inner BOP cavity, and thus the well, without any interference from the tubular.

Although a single laser delivery assembly is shown in the example of the embodiment of FIGS. 11 and 12, multiple laser sub sea, and sub sea in situ laser assemblies, assemblies of different shapes, and assemblies in different positions, may be employed. The ability to make precise and predetermined laser energy delivery patterns to tubulars and the ability to make precise and predetermined cuts in and through tubulars, provides the ability, even in an emergency situation, to sever the tubular without crushing it and to have a predetermined shape to the severed end of the tubular to assist in later attaching a fishing tool to recover the severed tubular from the borehole. Further, the ability to sever the tubular, without crushing it, provides a greater area, i,e., a bigger opening, in the lower section of the severed tubular through which drilling mud, or other fluid, can be pumped into the well, by the kill line associated with the BOP stack.

The body of the SLM may be a single piece that is machined to accommodate the laser delivery assembly, or it may be made from multiple pieces that are fixed together in a manner that provides sufficient strength for its intend use, and in particular to withstand pressures of 5,000 psi, 10,000 psi, 15,000 psi, 20,000 psi, and greater. The area of the body that contains the laser delivery assembly may be machined out, or otherwise fabricated to accommodate the laser delivery assembly, while maintaining the strength requirements for the body's intended use. The body of the SLM may also be two or more separate components or parts, e.g., one component for the upper half and one for the lower half. These components could be attached to each other by, for example, bolted flanges, or other suitable attachment means known to one of skill in the offshore drilling arts. The body, or a module making up the body, may have a passage, passages, channels, or other such structures, to convey fiber optic cables for transmission of the laser beam from the laser source into the body and to the laser delivery assembly, as well as, other cables that relate to the operation or monitoring of the laser delivery assembly and its cutting operation.

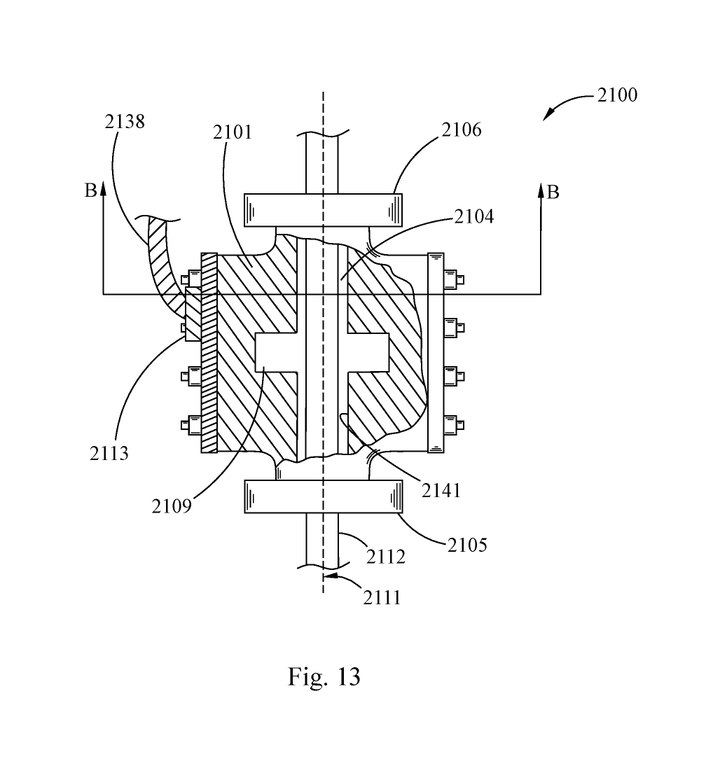

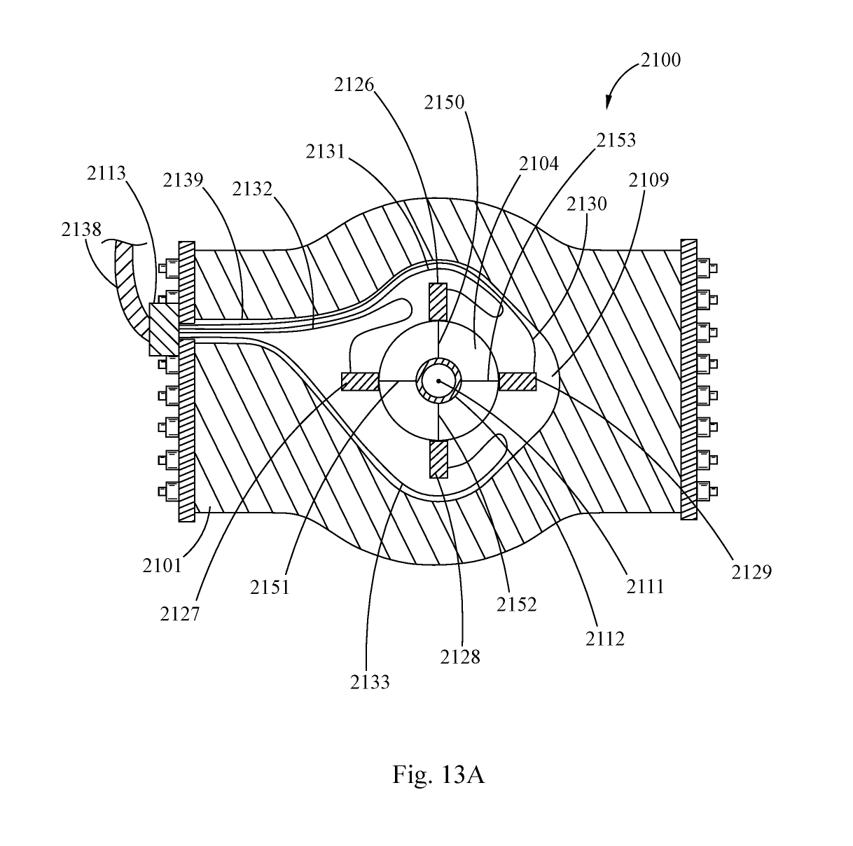

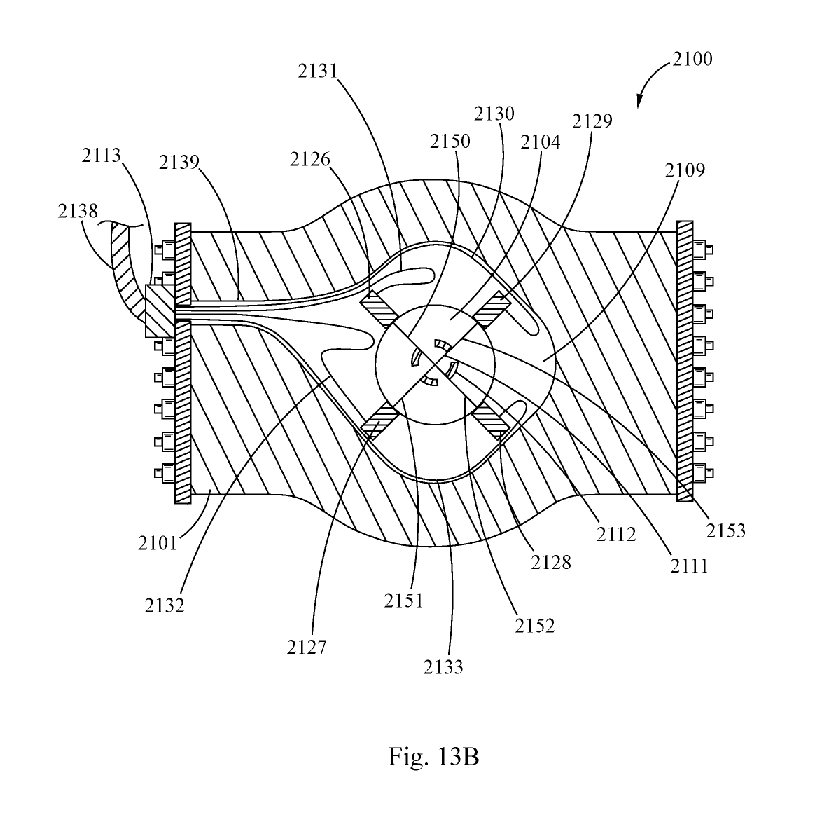

Turning to FIGS. 13 and 13A-13C there is shown an example of an embodiment of an sub sea in situ SLM that could be used in a laser assisted BOP stack. Thus, there is shown an SLM 2100 having a body 2101. The body has a cavity 2104, which cavity has a center axis (dashed line) 2111 and a wall 2141. The BOP cavity 2104 also has a vertical axis and in this embodiment the vertical axis and the center axis 2111 are the same, which is generally the case for BOPS. (The naming of these axes are based upon the configuration of the BOP and are relative to the BOP structures themselves, not the position of the BOP with respect to the surface of the earth. Thus, the vertical axis of the BOP will not change if the BOP, for example, were laid on its side.) Typically, the center axis of cavity 2111 is on the same axis as the center axis of the wellhead cavity or opening through which tubulars are inserted into the borehole.

The body 2101 contains sub sea laser delivery assembly 2109. There is also shown a tubular 2112 in the cavity 2104. The body 2101 also has a feed-through assembly 2113 for managing pressure and permitting power, and other cables, tubes, wires, fibers, lines and conveyance means, which may be needed for the operation of the laser cutter, to be inserted into the body 2101. The feed-through assembly 2113 connects with conduit 338 for conveyance to a power source for powering the sub sea lasers, or other sources of materials for the cutting operation.

FIGS. 13A to 13C show cross-sectional views of the embodiment shown in FIG. 13 taken along line B-B. FIGS. 13A to 13C also show the sequences of operation of the SLM 2100, in cutting the tubular 2112. In this embodiment the laser delivery assembly 2109 has four laser assemblies (e.g., laser array, beam handling, and cutters) 2126, 2127, 2128, and 2129. Flexible support cables are associated with each of the laser cutters. Thus, flexible support cable 2131 is associated with laser assembly 2126, flexible support cable 2132 is associated with laser assembly 2127, flexible support cable 2133 is associated with laser assembly 2128, and flexible support cable 2130 is associated with laser assembly 2129. The flexible support cables are located in channel 2139 and enter feed-through assembly 2113. In the general area of the feed-through assembly 2113, the support cables transition from flexible to semi-flexible, and may further be included in conduit 338 for conveyance to a high power laser, or other sources of materials for the cutting operation. The flexible support cables 2130, 2131, 2132, and 2133 have extra, or additional length, which accommodates the orbiting of the laser cutters 2126, 2127, 2128 and 2129 around the axis 2111, and around the tubular 2112.

FIGS. 13A to 13C show the sequence of activation of the SLM 2100 to sever a tubular 2112. In this example, the first view (e.g., a snap shot, since the sequence preferably is continuous rather than staggered or stepped) of the sequence is shown in FIG. 21A. As activated the four lasers assemblies 2126, 2127, 2128 and 2129 propagates (which may also be referred to as shooting or firing the laser to deliver or emit a laser beam) laser beams that travel along beam paths 2150, 2151, 2152 and 2153. The beam paths 2150, 2151, 2152 and 2153 extend from the laser cutters in the laser assemblies 2126, 2127, 2128 and 2129 toward the center axis 2111 and thus intersect the tubular 2112. The beams are directed toward the center axis 2111. As such, the beams are shot from within the BOP, from outside of the cavity wall 2141, and travel along their respective beam paths toward the center axis of the BOP. The laser beams strike tubular 2112 and begin cutting, i.e., removing material from, the tubular 2112.

If the cavity 2104 is viewed as the face of a clock, the laser cutters in the laser assemblies 2126, 2127, 2128 and 2129 could be viewed as being initially positioned at 12 o'clock, 9 o'clock, 6 o'clock and 3 o'clock, respectively. Upon activation, the laser cutters and their respective laser beams, begin to orbit around the center axis 2111, and the tubular 2112. (In this configuration the laser cutters would also rotate about their own axis as they orbit, and thus, if they moved through one complete orbit they would also have moved through one complete rotation.) In the present example the cutters and beams orbit in a counter clockwise direction, as viewed in the figures; however, a clockwise rotation may also be used.

Thus, as seen in the next view of the sequence, FIG. 13B, the laser cutters, 2126, 2127, 2128 and 2129 have rotated 45 degrees, with laser beams that travel along beam paths 2150, 2151, 2152 and 2153 having cut through four ⅛ sections (i.e., a total of half) of the circumference of the tubular 2112. FIG. 13C then shows the cutter having moved through a quarter turn. Thus, cutter 2126 could be seen as having moved from the 12 o'clock position to 9 o'clock position, with the other cutters having similarly changed their respective clock face positions. Thus, by moving through a quarter turn the beam paths 2150, 2151, 2152 and 2153 would have crossed the entire circumference of the tubular 2112 and the laser beams traveling along those beam paths would severe the tubular.

During the cutting operation, and in particular for circular cuts that are intended to sever the tubular, it is preferable that the tubular not move in a vertical direction. Thus, at or before the laser cutters are fired, the pipe rams, the annular preventer, or a separate holding device should be activated to prevent vertical movement of the pipe during the laser cutting operation. The separate holding device could also be contained in the SLM.

The rate of the orbital movement of the laser cutters is dependent upon the number of cutters used, the power of the laser beam when it strikes the surface of the tubular to be cut, the thickness of the tubular to be cut, and the rate at which the laser cuts the tubular. The rate of the orbital motion should be slow enough to ensure that the intended cuts can be completed. The orbital movement of the laser cutters can be accomplished by mechanical, hydraulic and electro-mechanical systems known to the art.

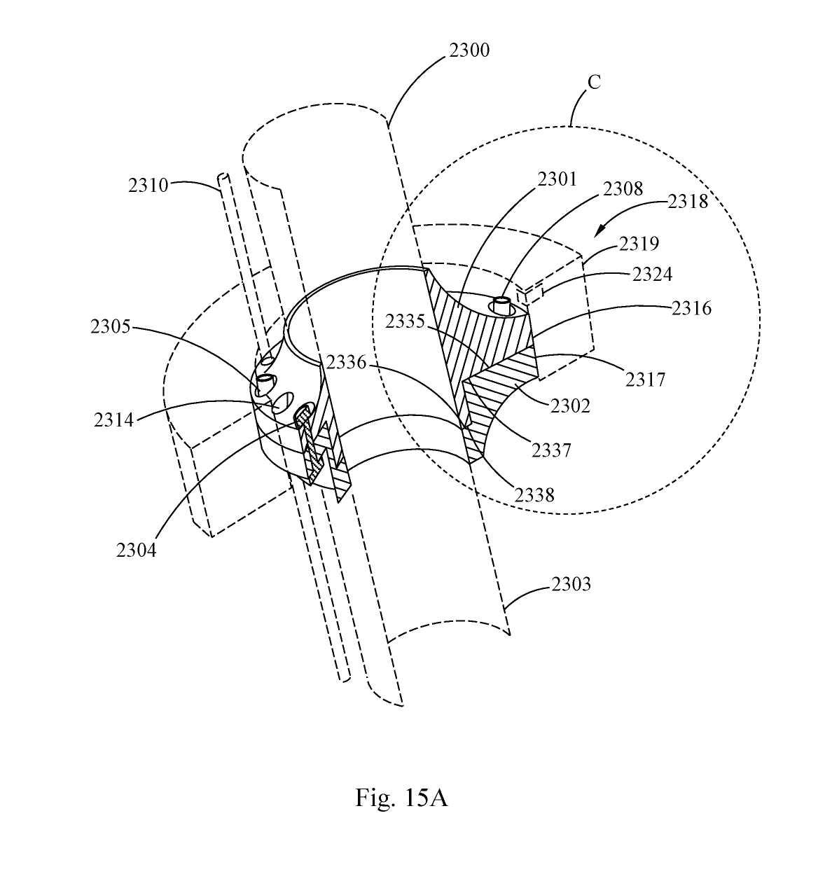

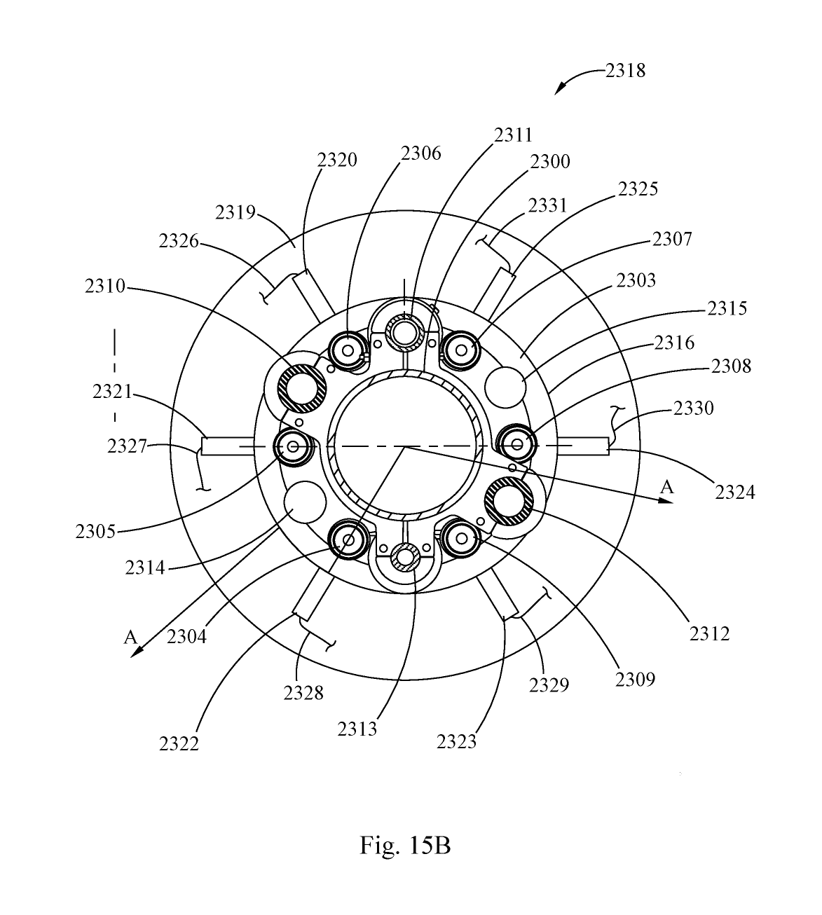

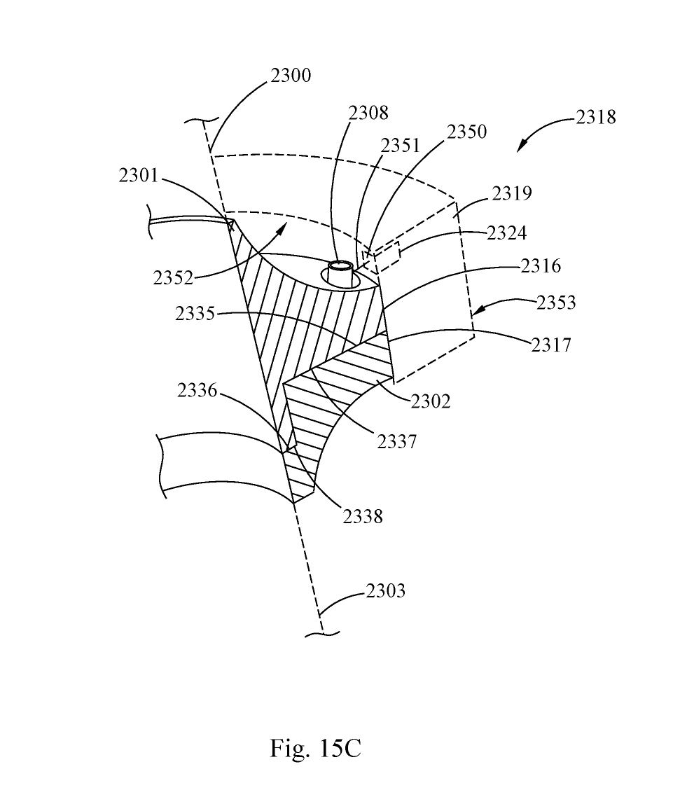

In FIGS. 15A-C and 16A-B there are shown exemplary embodiments of laser modules associated with a riser having a flanged coupling, such as an HMF coupling. In the “A” figures there is shown the riser flanges in solid lines and the related tubes and the laser module in phantom lines. The “A” figures also have a cut away view with the section taken along lines A-A of the “B” figures removed from the view. In the “B” figures, there is shown a transverse cross-section of the flange and laser module taken along the transverse connection between the two flanges.

Thus, turning to FIGS. 15A & 15B there is provided a riser section center tube 2300 that has a flange 2301 attached at its lower end. Riser section center tube 2303 has a flange 2302 attached at it upper end. (Although not shown in this figure, it is recognized that riser section center tube 2300 would have a flange attached to its upper end and that riser section center tube 2303 would have a flange attached to its lower end.) Flange 2301 is attached to upper flange 2302 by bolts and nuts 2304, 2305, 2306, 2307, 2308, 2309. Also associated with the riser sections 2300, 2303 and extending through the flanges 2301, 2302 are a choke line 2310, a booster line 2311, a kill line 2312, a hydraulic line 2313 and blanks (e.g., open unfilled holes in the flange) 2314, 2315. Flange 2301 has an outer surface 2316, a mating surface 2335 and a shoulder surface 2336. Flange 2303 has an outer surface 2317 a mating surface 2337 and a shoulder surface 2338. When the flanges 2301 and 2302 are engaged and connected, surface 2335 is engaged against surface 2337 and surface 2336 is engaged against surface 2338. Sub sea laser assemblies 2320, 2321, 2322, 2323, 2324, 2325 (which each have a laser source and a laser cutter) have flexible support cables 2326, 2327, 2328, 2329, 2330, 2331 respectively, which provide power to the lasers in the laser assemblies. The laser assemblies are contained within housing 2319 of laser module 2318. In this embodiment the laser cutters are positioned adjacent the heads of the bolts, see, e.g., laser cutter 2324 and bolt 2308, and have beam paths direct toward the bolts.

Turning to FIG. 15C, which is an enlarged view of a section of FIG. 15A, there is shown a laser discharge end 2350 of the laser cutter of laser assembly 2324. A beam path 2351, which a laser beam propagated from laser cutter of laser assembly 2324 would follow, extends between laser discharge end 2350 and the component of the riser section to be cut, which in this illustration would be bolt 2308. The housing 2319 has an inner area 2352 that is configured or otherwise adapted to contact, be associated with or engage the components of the riser that are to be cut by the laser. The housing 2319 has an outer area 2353 that is removed from the inner area 2352. In general, the housing inner area will be closest to the riser and the housing outer area will be furthest from the riser.

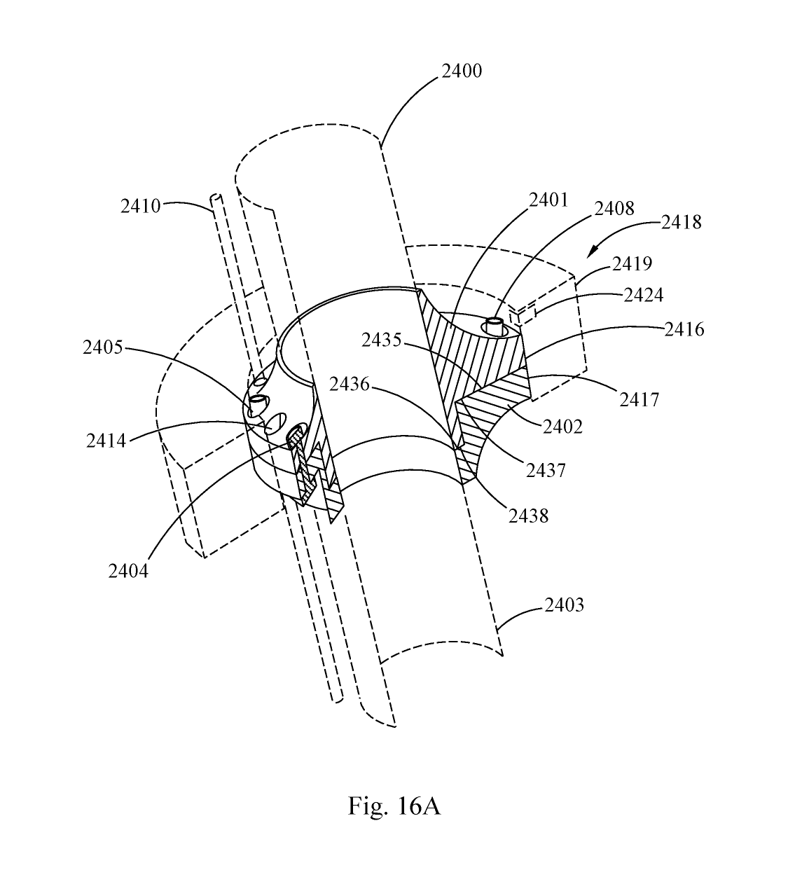

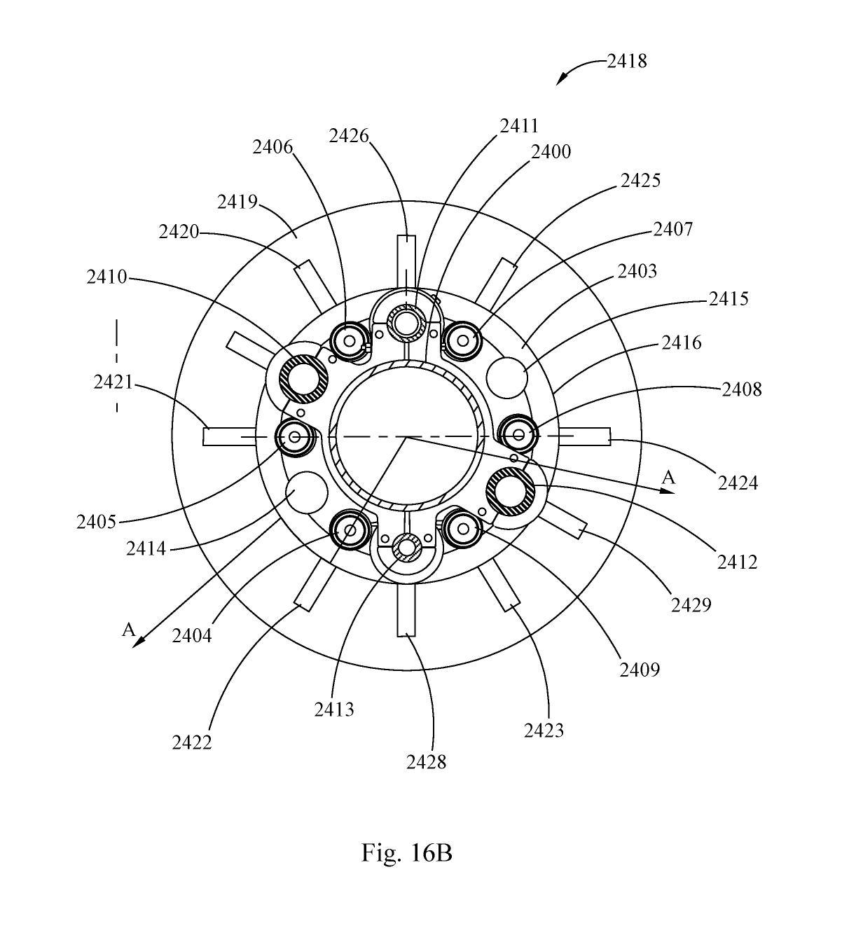

Turning to FIGS. 16A & 16B there is provided a riser section center tube 2400 that has a flange 2401 attached at its lower end. Riser section center tube 2403 has a flange 2402 attached at it upper end. (Although not shown in this figure, it is recognized that riser section center tube 2400 would have a flange attached to its upper end and that riser section center tube 2403 would have a flange attached to its lower end.) Flange 2401 is attached to upper flange 2402 by bolts and nuts 2404, 2405, 2406, 2407, 2408, 2409. Also associated with the riser sections 2400, 2403 and extending through the flanges 2401, 2402 are a choke line 2410, a booster line 2411, a kill line 2412, a hydraulic line 2413 and blanks (e.g., open unfilled holes in the flange) 2414, 2415. Flange 2401 has an outer surface 2416, a mating surface 2435 and a shoulder surface 2436. Flange 2403 has an outer surface 2417 a mating surface 2437 and a shoulder surface 2438. When the flanges 2401 and 2402 are engaged and connected, surface 2435 is engaged against surface 2437 and surface 2436 is engaged against surface 2438. Sub sea laser assemblies having laser cutters 2420, 2421, 2422, 2423, 2424, 2425, 2426, 2427, 2428, 2429 each having a flexible support cable (not shown). The laser assemblies are associated with a power source, e.g., sub sea battery, sub sea generator, surface generator, etc. The laser assemblies are contained within housing 2419 of laser module 2418. In this embodiment the laser assemblies are positioned adjacent the heads of the bolts, see, e.g., laser cutter of laser assembly 2424 and bolt 2408, and adjacent the external pipes, see, e.g., laser cutter of laser assembly 2426 and booster line 2411. The laser cutters have beam paths direct toward the bolts and external pipes.

In another embodiment the laser cutters of the sub sea laser assemblies are positioned adjacent the connection of the two flanges, i.e., ring where the outer surfaces and mating surfaces converge. Thus, in this embodiment the laser cutters are directed into the flange, and have beam paths that intersect, or follow, the annular disc created by the engagement of mating surfaces. In another embodiment the laser cutters are positioned adjacent the shoulders. In this way the laser has a beam path that is directed from the laser cutter to the area where the shoulders engage each other. Additionally, in this embodiment the beam path is directed through the thinnest area of the flange connections, and thus presents the laser cutters with the least amount of material to remove. In a further embodiment the laser cutters are positioned adjacent the nuts of the bolts and have beam paths direct toward the nuts.

A housing for a laser module can be integral with one of the flanges. The house can be in two pieces, with each piece being integral with a flange, and thus, the housing pieces will be joined together as the flanges are connected. The housing may extend inwardly, and join with the central tube, either above or below the flange. When the housing extends inwardly it may be configured to keep water out of the beam path between the laser cutter and the material to be cut, e.g., a bolt head. However, in this housing configuration, care must be taken so that the housing is assembled in a manner that provides for access to the bolts and nuts, as well as, passage for the external pipes. The housing may be in a split ring type of configuration or may be in two or more semi-circular sections, which sections are connected together around the flanges after the flanges have been bolted together, or around the center tube or riser.

Preferably, upon activation the laser cutters will propagate (also commonly referred to as firing or shooting the laser to create a laser beam) their respective laser beams along their respective beam paths. The cutters will then rotate around the riser causing the beam path to cut additional material. Non-rotating laser cutters may be utilized, however, in such a case to assure the quick, clean and controlled severing of the riser greater numbers of cutters should be used. The delivery of the high power laser energy beam will cut, or otherwise, remove the material that is in the beam path. Thus, the high power laser energy, for example, can sever the bolts holding two riser flanges together; and separate or sever the two riser sections that were held together by those bolts.

Although not shown in the figures, the laser modules and the teachings of this specification may be utilized with any type of riser coupling presently existing, including dog styles couplings and rotating key style couplings, as well as, future riser coupling systems, yet to be developed, and riser coupling systems, which the teachings herein may give rise to.

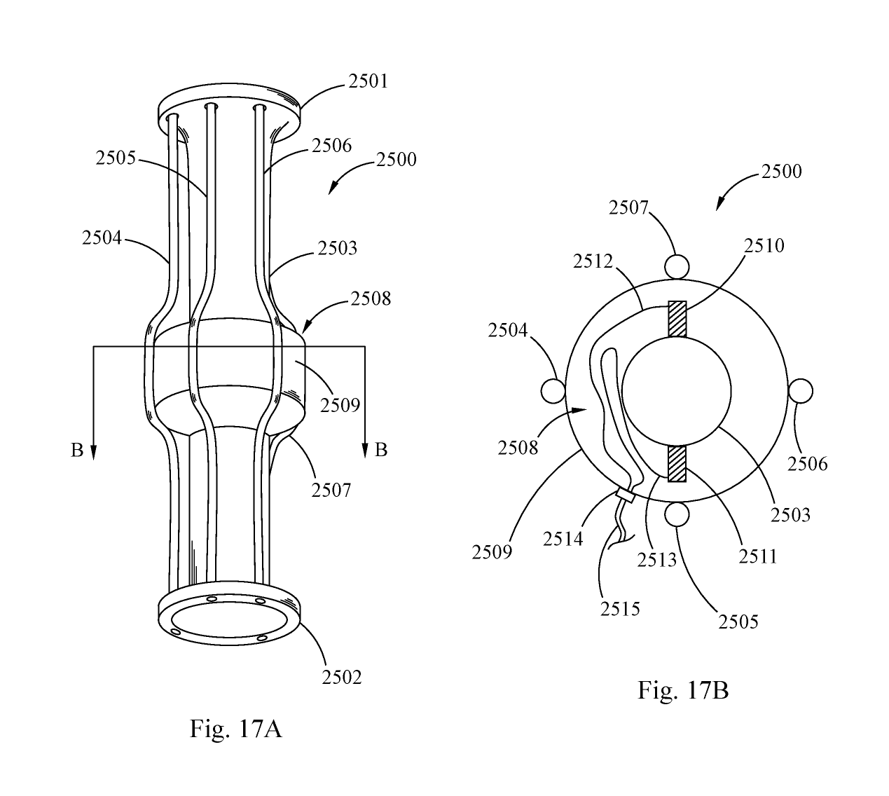

FIGS. 17A & 17B show an embodiment of a laser riser disconnect section. FIG. 17B is a transverse cross-sectional view of the laser riser disconnect section taken along line B-B of FIG. 17A. There is provided a riser section 2500. The riser section 2500 has a center tube 2503 that has at its ends an upper coupling 2501 and a lower coupling 2502. These coupling may be any type of riser coupling known to those of skill in the drilling arts and would include flange-style, dog-style and rotating key-style couplers. The riser section 2500 has associated therewith four external pipes, a kill line 2504, a choke line 2505, a booster line 2506 and a hydraulic line 2507. The riser section 2500 has a laser module 2508 having a housing 2509. The external pipes are configured to go around, e.g., be exterior to, the laser housing. Thus, laser cutters of sub sea laser assemblies 2510, 2511 can be adjacent the center tube 2503 of the riser section 2500. The laser assemblies have flexible support cables 2512, 2513 that are feed through feed through assembly 2514 and into conduit 2515 for connection to a power source and other materials, and information, that may be utilized in the operation, control or monitoring of the laser assemblies, their laser and cutters, and the laser operation. The flexible support cables have extra slack or length to accommodate the rotation of the laser assemblies 2510, 2511 around the circumference of the center tube 2503. In the embodiment of FIG. 17B the laser assemblies and thus their cutters would have to move about ½ of a rotation to sever the center tube 2503.

It is desirable to have quick disconnect valves or assemblies on the external pipes to facilitate their disconnecting, and closing off or shutting off, when the center tube of the riser, the external pipes, the bolts or other means holding the riser sections together, or all of them are severed. These disconnect means for the external tubes should be positioned in a manner that prevents spillage of the material they are carrying if the laser module is activated and severs the riser or otherwise weakens the riser so that a quick disconnect is possible.

The laser modules, sub sea laser assemblies, or laser cutters may contain a shield to provide protection to the laser cutters, to a lesser or greater extent, from the water, pressure or other subsea environmental conditions in which the riser is deployed. The shield may be part of the housing or it may be a separate component. It may assist in the management of pressure, or contribute to pressure management, for the laser module. The shield may be made of a material, such as steel or other type of metal or other material, that is both strong enough to protect the laser cutters and yet be quickly cut by the laser beam when it is fired. The shield could also be removable from the beam path of the laser beam. In this configuration, upon activation of the laser module the shield would be moved away from the beam path. In the removable shield configuration, the shield would not have to be easily cut by the laser beam.

Although single laser modules are shown for a single riser section, multiple laser modules, modules of different shapes, and modules in different positions, may be employed. Further multiple riser sections each having its own laser module may be utilized in a riser at various positions between the offshore rig and the BOP. The ability to make precise and predetermined laser energy delivery patterns to the riser and the ability to make precise and predetermined cuts in and through risers, provides the ability, even in an emergency situation, to sever the riser without crushing it and to do so with minimal damage to the riser.

The riser laser module may be a single piece that is machined to accommodate the laser cutters, or it may be made from multiple pieces that are fixed together in a manner that provides sufficient strength for its intend use, and in particular to withstand pressures of 1,000 psi, 2,000 psi, 4,500 psi, 5,000 psi and greater. The modules need to be able to operate at the pressures that will occur at depths where the BOP is located, thus for example at depths of 1,000 ft, 5,000 ft, 10,000 ft and potentially greater. The area of the housing that contains the laser cutter may be machined out, or otherwise fabricated to accommodate the laser cutters, while maintaining the strength requirements for the body's intended use. The housing of the laser module may also be two or more separate components or parts, e.g., one component for the upper half and one for the lower half, or one more components for the section of a ring that is connected around the riser. These components could be attached to each other by, for example, bolted flanges, or other suitable attachment means known to one of skill in the offshore drilling arts. The laser module or the housing may have a passage, passages, channels, or other such structures, to convey fiber optic cables for transmission of the laser beam from the laser source into the housing and to the laser cutter, as well as, other cables that relate to the operation or monitoring of the laser delivery assembly and its cutting operation.

The greater the number of laser cutters in a rotating laser module, the slower the rate of orbital motion can be to complete a cut in the same amount of time. Further, increasing the number of laser cutters decreases the time to complete a cut of a riser, without having to increase the orbital rate. Increasing the power of the laser beams will enable quicker cutting of tubulars, and thus allow faster rates of orbiting, fewer laser cutters, shorter time to complete a cut, or combinations thereof.

### EXAMPLE 1

A sub sea laser assembly of the embodiment of FIG. 1, 2, 3, 4, 5, 6, 7, 8, 9, 10, 11, 12, 13, 14, 15, 16, or 17 has a visible blue light output laser source comprising a blue laser diode based system can be used to create Stimulated Raman Scattering (SRS) gain in an optical fiber. The blue laser source can be referred to as the pump laser for the Raman laser. The blue laser source can also include a solid state laser source such as a Thulium doped optical fiber. The optical fiber can comprise a multiple layered structure that includes a core region and one or more cladding layers around the core. The numerical aperture (NA) of the core and cladding layers can be varied depending on the core and cladding dopant. A separate SRS laser resonator comprising reflective mirrors, optical beam splitters and lenses can be constructed to enhance the SRS process in the optical fiber. The SRS resonator is designed to allow a light output from the fiber such that aspects of the light are enhanced this can be the color of the light, the laser brightness or the laser line width.

The blue laser diode source can be individual laser diodes or a packaged array. An example of a packaged array could include a commercially available Osram PLPM4-450 50 W diode package. The blue laser sources can be manipulated to improve the spatial density of laser beams output from the sources. The beam collimation and pointing direction of the sources can also be enhanced. The enhanced beam output from the sources can be configured to launch into an optical fiber. The NA of the fiber is selected to allow the efficient launch of a focused blue laser beam. The optical elements for the enhanced beam comprise lenses and mirrors. This optical system can be referred to as a Beam Transformation System (BTS). The blue laser diode source array can be constructed to allow two arrays to be combined into a more powerful array using an optical polarizer and half wave rotation optical waveplate. This is polarization beam combining method (PBC).

The output can be further enhanced using dichroic beam combining (DBC) technique. The dichroic beam combining can be accomplished using optical dichroic mirrors or volume Bragg gratings. It can also be accomplished using a regular surface grating either transmissive or reflective. The DBC can allow one array to be operated at a wavelength within the Raman gain bandwidth of the optical fiber and be transmitted by the combiner. A second array can be selected to be operated at a wavelength within the Raman gain bandwidth of the optical fiber and be reflected by the combiner. Using PBC and DBC allows a fourfold/manifold increase in laser power for launch into the optical fiber. The BTS can be designed to allow the blue source array to be launched into a fiber with a 100 μm core. Using laser powers up to 200 W at a wavelength of 450 nm an output wavelength at 459 nm from the SRS laser resonator can be achieved. An implementation of a SRS laser resonator could comprise a fiber of length 200 m, a high reflector and a partial reflector with reflectivity of 70% at the 459 nm wavelength. The SRS resonator can further include lenses to launch and collimate the laser beams and dichroic mirrors to separate the 450 nm and 459 nm laser beams. The Raman laser in this scheme resonates in the core of the optical fiber and the 450 nm laser pump is also launched into the core. A typical value for the NA of the core of this optical fiber would 0.22 NA. This implementation of the laser can be expected to have conversion efficiency of the 450 nm input laser beam (pump) to the SRS (Raman) 1st Stokes 459 nm output beam of 65% using accepted theoretical model systems as described in the literature. At 200 W of launched power this would create laser beam at 459 nm with a power of 80 W. Using a mm.m Radian definition of beam brightness the Raman laser would have a brightness of 44 mm.mRadians (mm.mR) from the 100 um core with a 0.22 NA.

### EXAMPLE 2

A sub sea laser assembly of the embodiment of FIG. 1, 2, 3, 4, 5, 6, 7, 8, 9, 10, 11, 12, 13, 14, 15, 16, or 17 has a sub sea cladding pumped fiber laser source. The pump laser beam can be launched into a cladding layer of the fiber. This cladding can be designed to have a similar NA as the core in the previous discussion, e.g., 0.22 NA. The cladding can have the same 100 μm diameter also. The blue laser system can therefore use the same BTS and launch scheme. The core of the fiber can be reduced to a smaller value, say 70 μm. The relationship of the core to cladding ratio can be studied using theoretical models and has been discussed in the literature. The core is now designed to have a lower NA than the cladding to allow light generated in the core to remain guided in the core.

The impact of design of the NA of the core to the performance of the Raman laser influences loss mechanisms, bend radius of the fiber and launch parameters for the resonated Raman beams. A typical value for the NA of the core would 0.11. The 459 nm beam is resonant in the core, and typically, only this can be done using a physical aperture to limit the 459 nm beam size in the collimated beam space. Considerable care must be taken to suppress the 2nd Stokes if 459 nm output is desired. The use of spectrally selective mirrors and careful selection of fiber length and output mirror reflectivity of the Raman laser is required. Using a value of 70 μm core to 100 μm cladding the laser can perform with comparable efficiency as the single core operation previously discussed, e.g., 65%. However the brightness of the laser can be increased as the output is from a 70 um core with a 0.11 NA. This provides an output brightness of 15 mm.Rad. Using a 100 W pump provides a 65 W output with three times the brightness, this equates to a 200% increase in power density on a laser target. The 200 W pump will have a slightly lower efficiency due to spectral broadening relative to the Raman gain bandwidth, 50%. However the net increase in power density will be 150% over the original pump source.

Generally, the selection of core size and fiber NA has a large impact on brightness and net efficiency of the system. For example a 50 um core and 0.08 NA will increase brightness by a factor of 6. The smaller core will decrease conversion efficiency from 65% to 45%. This leads to a net increase of power density on target of 270%. A balance of power and power density for the specific application will be used to optimize total system performance.

It being understood that the forgoing Example 2, is based upon an illustrative diode wavelength of 450 nm, and that these diodes can typically have wavelength ranging or varying from about 400 nm to 460 nm, which variation in turn could result in a slightly different output wavelength.

### EXAMPLE 3

A sub sea laser assembly of the embodiment of FIG. 1, 2, 3, 4, 5, 6, 7, 8, 9, 10, 11, 12, 13, 14, 15, 16, or 17 has a sub sea laser source related to a method of suppressing the 2nd Stokes in the higher brightness Raman laser. The blue source pump laser generates Raman gain as previously in the core and cladding. The 1st Stokes Raman wavelength at 459 nm for a 450 nm pump is created in a resonator as above. The resonator is now designed to resonate a 2nd Stokes Raman wavelength at 468 nm, FIG. C. The 468 nm beam is resonant in the core only this can be done using a physical aperture to limit the 468 nm beam size or via natural gain and loss mechanisms in the fiber itself. The Raman resonator is built using a second partially reflective surface for the 468 nm beam as an output coupler for the Raman laser.

Using theoretical models the reflectivities of the mirrors for the 1st and 2nd Stokes can be selected to optimize output efficiency at 468 nm. Typical embodiment of the system demonstrated experimentally uses >99% reflectivities for both mirrors at 459 nm and one of the 468 nm mirrors and only a low reflectivity of 10% for the second mirror in the 468 nm resonator. The low reflectivity output coupler allows easier suppression of the 3rd Stokes as the resonant field at the 2nd Stokes is significantly reduced relative to the single Stokes implementation. The conversion efficiency of the 2nd Stokes output at 468 nm is comparable to the single Stokes only resonator at 60%. The 468 nm output is originated from a smaller core with a lower NA. The mm.mR (mm mrad) beam brightness is now 15 mm.mR.

The BTS system used above to launch 50 W, 100 W via PBC or 200 W using a DBC and PBC scheme can provide a fiber output with a 0.2 NA and 100 μm beam size. Multiple fibers can be brought together and launched into a single larger aperture fiber with a suitable NA, typically slightly larger than the smaller fibers. If we select a fiber of 1500 nm core size and 0.22 NA this would allow 180 100 μm fibers to be launched into the single large fiber. This provides a capability to launch 9, 18 or 36 kW into the fiber.

### EXAMPLE 4

A sub sea laser assembly of the embodiment of FIG. 1, 2, 3, 4, 5, 6, 7, 8, 9, 10, 11, 12, 13, 14, 15, 16, or 17 utilizes beam combiners that can use spectral, coherent and fiber beam combining, and combinations and variations of these, as well as, other beam combining technologies. In the present inventions embodiments of these technologies are modified, and adapted for use in confined and harsh sub sea and riser-BOP assemblies environment and conditions. General teachings and disclosure of beam combining technology are provided in US Patent Publication Nos. 2011/0305256, and 2012/0281948 and in U.S. Pat. Nos. 8,526,110 and 7,884,997 the entire disclosures of each of which are incorporated herein by reference.

### EXAMPLE 5

A sub sea laser assembly of the embodiment of FIG. 1, 2, 3, 4, 5, 6, 7, 8, 9, 10, 11, 12, 13, 14, 15, 16, or 17 use an array of diode lasers. Diode lasers typically produce complex, highly asymmetric laser beams. The initial laser beams are directed to an optics assembly (this assembly is also referred to as a beam transformation system or BTS). The optics assembly redirects the initial lasers beams so that their beam paths are parallel and in the direction of the beam paths exiting the laser cutters. At this point the optics assembly can also begin to process the initial laser beams, e.g., shapes, collimates, focuses, collimates the fast axis, collimates the slow axis, adjusts beam packaging (to preferably reduce spacing between the beams), combines the beams, and combinations and variations of these.

The optics assemblies, e.g., the BTSs, are used to process these raw laser beams from the diode laser. The BTS generally can circularize the laser beams, and reduce and in need be, eliminate empty space between the individual raw laser beams, e.g., the beam lets.

In some embodiments the raw laser beams, e.g., the beamlets do not need to be circularized, and only the empty space needs to be eliminated. In other embodiments the beam lets are circularized and the empty space is eliminated.

BTS are disclosed and taught in the following U.S. Pat. Nos. 9,001,426, 8,422,148, 7,986,461, 7,782,535, 6,556,352, 6,462,883, 6,377,410, 8,520,311, 7,079,566 and 5,513,201, the entire disclosures of each of which are incorporated herein by reference.

The apparatus and methods of the present invention may be used with drilling rigs and equipment such as in exploration and field development activities and product activities and decommissioning activities. Thus, in addition to off shore, and sub sea activities, they may be used with, by way of example and without limitation, land based rigs, mobile land based rigs, fixed tower rigs, barge rigs, drill ships, jack-up platforms, and semi-submersible rigs. They may be used in operations for advancing the well bore, finishing the well bore and workover activities, including perforating the production casing.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and with existing equipment or activities which may be modified, in-part, based on the teachings of this specification. Further, the various embodiments set forth in this specification may be used with each other in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

What is claimed:

1. A blowout preventer stack comprising:
a ram movable from a first position to a second position, thereby defining a ram path;
a sub sea laser assembly comprising a sub sea laser in optical association with a laser cutter for generating and emitting a high power laser beam and thereby defining a laser beam path; and,
the sub sea laser cutter positioned relative to the ram and facing a pressure containment cavity formed within the stack, wherein the beam path enters into the pressure containment cavity and the second position of the ram is located within the pressure containment cavity.

2. The blowout preventer stack of claim 1, wherein the stack comprises a frame and a sub sea laser housing; the sub sea laser housing encompassing and protecting the sub sea laser from the sub sea environment.

3. The blowout preventer stack of claim 2, wherein the sub sea laser housing comprises a means for cooling the sub sea laser.

4. The blowout prevent of claim 2, wherein the sub sea laser comprises an array of a plurality of diode lasers, the diode lasers each generating an initial laser beam having a wavelength of about 400 nm to about 900 nm; a beam combiner; whereby the beam combiner provides an operational laser beam having a power of at least about 5 kW.

5. The blowout prevent of claim 3, wherein the sub sea laser comprises an array of a plurality of diode lasers, the diode lasers each generating an initial laser beam having a wavelength of about 400 nm to about 900 nm; a beam combiner; whereby the beam combiner provides an operational laser beam having a power of at least about 5 kW.

6. The blowout preventer stack of claim 1, wherein the sub sea laser assembly comprises a power source, a semiconductor laser, and a means for cooling the laser

7. The blowout preventer of claim 6, wherein the power source is selected from the group consisting of an electric power line, a battery, a generator and an optical fiber.

8. The blowout preventer stack of claim 6, wherein the means cooling is selected from the group consisting of non circulating fluid in thermal association with a body of water in which the blowout preventer is submerged, a solid member in thermal association with a body of water in which the blowout preventer is submerged, a circulating fluid, and a body of water in which the blowout preventer is submerged.

9. The blowout preventer stack of claim 1, wherein the sub sea laser comprises a means for cooling the sub sea laser.

10. The blowout preventer stack of claim 9, wherein the means cooling is selected from the group consisting of non circulating fluid in thermal association with a body of water in which the blowout preventer is submerged, a solid member in thermal association with a body of water in which the blowout preventer is submerged, a circulating fluid, a circulating fluid comprising a liquid from the body of water in which the blowout preventer is submerged, and a body of water in which the blowout preventer is submerged.

11. The blowout prevent of claim 1, wherein the sub sea laser comprises an array of a plurality of diode lasers, the diode lasers each generating an initial laser beam having a wavelength of about 400 nm to about 900 nm; a beam combiner; whereby the beam combiner provides an operational laser beam having a power of at least about 5 kW.

12. A blowout preventer comprising:
a. a sub sea in situ laser assembly, the assembly comprising a plurality of semiconductor lasers and a laser cutter for emitting a high power operational laser beam having a wavelength of about 400 nm to about 1,100 nm and a power of at least about 2 kW;
b. a pressure containment cavity within a stack for passing tubulars therethrough; and,
c. the laser cutter defining a beam path, the beam path extending into the pressure containment cavity.

13. The blowout preventer of claim 12, wherein the plurality of semiconductor lasers comprises at least 10 diode lasers.

14. The blowout preventer of claim 13, wherein the diode lasers have a wavelength form 400 nm to 500 nm.

15. The blowout preventer of claim 13, wherein the diode lasers have a wavelength form 500 nm to 600 nm.

16. The blowout preventer of claim 13, wherein the diode lasers have a wavelength form 600 nm to 880 nm.

17. The blowout preventers of claims 12, 13, 14, and 15 comprising a laser cooling assembly.

18. The blowout preventer of claim 12, comprising a laser cooling assembly selected from the group consisting of a non circulating fluid in thermal association with a body of water in which the blowout preventer is submerged, a solid member in thermal association with a body of water in which the blowout preventer is submerged, a circulating fluid, a circulating fluid comprising liquid from a body of water in which the blowout preventer is submerged, and a body of water in which the blowout preventer is submerged.

19. A subsea blowout preventer comprising:
a. a sub sea laser assembly, the assembly comprising a protective laser housing, the housing containing and protecting a semiconductor laser, a beam combiner, and a laser cutter for emitting a high power operational laser beam having a wavelength of about 400 nm to about 1,100 nm and a power of at least about 2 kW;
b. a ram preventer, having a ram;
c. a pressure containment cavity for passing tubulars therethrough;
d. the laser cutter having a beam path;
e. the ram capable of movement into the pressure containment cavity;
f. an area within the pressure containment cavity for engagement of the ram with a tubular; and,
g. the beam path directed adjacent the area within the pressure containment cavity for engagement of the ram with the tubular.

20. A laser assisted blowout preventer comprising:
a. a frame;
b. a blowout preventer stack mechanically associated with the frame, whereby the frame at least in part encompasses and protects the blowout preventer stack, the blowout preventer stack comprising;
i. a pressure containment cavity formed within the blowout preventer stack for passing tubulars therethrough; and,
ii. a sub sea high power laser assembly comprising a protective housing, a laser, a power source, and a laser cutter, the laser cutter positioned adjacent the pressure containment cavity.

21. The blowout preventer of claim 20, wherein the laser assembly comprises a laser cooling assembly.

22. The blowout preventer of claim 21, wherein the laser cooling assembly is selected from the group consisting of a non circulating fluid in thermal association with a body of water in which the blowout preventer is submerged, a solid member in thermal association with a body of water in which the blowout preventer is submerged, a circulating fluid, a circulating fluid comprising liquid from a body of water in which the blowout preventer is submerged, and a body of water in which the blowout preventer is submerged.

23. The blowout preventer of claim 21, wherein the housing is mechanically affixed to the frame.

24. The blowout preventer of claim 21, wherein the housing is a body of a laser shear ram.

25. The blowout preventer of claim 21 is the laser assembly is an in situ laser assembly.

26. A laser assisted subsea blowout preventer drilling system, the system comprising:
a. a subsea riser;
b. a blowout preventer stack;
c. the blowout preventer stack comprising:
i. a blowout preventer stack cavity for passing tubulars therethrough, wherein the blowout preventer stack cavity is in fluid communication with the subsea riser;
ii. a sub sea laser delivery assembly comprising a protective housing, a plurality of diode lasers, a beam combiner and a laser cutter for providing a high power laser beam; and,
iii. a shear ram assembly having an opposed pair of shear rams, wherein the laser delivery assembly is mechanically associated with the shear ram assembly.

27. An offshore drilling rig having a laser assisted subsea blowout preventer system for the rapid cutting of tubulars in the blowout preventer during emergency situations, the laser system comprising:
a. a riser capable of being lowered from and operably connected to an offshore drilling rig to a depth at or near a seafloor;
b. a blowout preventer capable of being operably connected to the riser and lowered by the riser from the offshore drilling rig to the seafloor;
c. a sub sea high power laser assembly comprising a sub sea laser and a laser cutter; and,
d. the laser cutter operably associated with the blowout preventer and riser, whereby the laser cutter is capable of being lowered to at or near the seafloor and upon activation deliver a high power laser beam to a tubular that is within the blowout preventer.

28. A subsea blowout preventer stack comprising:
a ram movable from a first position to a second position; and,
a sub sea high power laser assembly for directing a high power operational laser beam into a pressure containment cavity formed within the stack.

29. The subsea blowout preventer stack of claim 28, wherein the sub sea laser assembly is an in situ sub sea laser assembly.

30. A shear laser module for use in a blowout preventer stack, the module comprising:
a. a body having a first blowout preventer stack connector and a second blowout preventer stack connector;
b. the body having a cavity for passing tubulars therethrough and conveying and controlling a flow of a drilling fluid therethrough; and,
c. a sub sea in situ laser assembly comprising a laser and a laser cutter in the body and having a beam path;
d. wherein the beam path travels from the laser cutter into the cavity and to any tubular that may be in the cavity.

31. The shear laser module of claim 30, wherein the laser assembly comprises a plurality of diode lasers.

32. The shear laser module of claim 30, wherein the laser assembly comprises a cooling assembly.

33. The shear laser module of claim 30, wherein the laser assembly comprises a means for cooling the laser.

34. The shear laser module of claim 30, wherein the laser assembly comprises a beam combiner.

35. A laser module for use with a marine riser, the laser module comprising:
a. a housing configured for mechanical association with a marine riser, the housing defining an inner area, whereby at least a portion of the marine riser\is contained within the inner area upon engagement of the housing with the riser;
b. the housing having a sub surface laser assembly in optical communication with a first laser cutter and a second laser cutter;
c. the first and second laser cutters, being positioned within the housing and the first and second laser cutters each having a laser discharge end;
d. a first beam path extending from the laser discharge end of the first laser cutter to the inner area of the housing; and
e. a second beam path extending from the laser discharge end of the second laser cutter to the inner area of the housing.

36. A laser-riser blowout preventer package for operably releasably associating an offshore drilling rig, a vessel or a platform on a surface of a body the water with a borehole in a seafloor of the body of water, the laser-riser blowout preventer package comprising:
a. a riser section comprising a first and a second end, wherein the first end has a first coupling and the second end has a second coupling;
b. a laser module, comprising a sub sea in situ laser assembly, operably associated with the riser section; and,
c. and a blowout preventer configured to be operably associated with the riser section and the borehole;
d. wherein, when the laser-riser blowout preventer package is deployed and operably associating the offshore drilling rig with the borehole in the seafloor the offshore drilling rig, vessel or platform is mechanically connected and in fluid communication with the borehole; and, the laser module upon firing a laser beam can completely cut the riser section at a predetermined location on the riser section, thereby releasing the offshore drilling rig, vessel or platform from the blowout preventer.
